(19) United States
(12) Patent Application Publication
(10) Pub. No.: US 2024/0306060 A1
(43) Pub. Date: Sep. 12, 2024

(54) BASE STATION-SIDE ELECTRONIC DEVICE AND TERMINAL-SIDE ELECTRONIC DEVICE FOR WIRELESS COMMUNICATION SYSTEMS

(71) Applicant: Sony Group Corporation, Tokyo (JP)

(72) Inventors: Bin SHENG, Nanjing, Jiangsu (CN); Lirong HU, Nanjing, Jiangsu (CN); Zhikun WU, Beijing (CN); Chen SUN, Beijing (CN)

(73) Assignee: Sony Group Corporation, Tokyo (JP)

(21) Appl. No.: 18/569,617

(22) PCT Filed: Jun. 13, 2022
(86) PCT No.: PCT/CN2022/098317

§ 371 Date: Dec. 13, 2023

(30) Foreign Application Priority Data
Jun. 21, 2021 (CN) 202110685773.8

(51) Int. Cl. H04W 36/06; H04B 7/024; H04W 36/30

(52) U.S. Cl. CPC H04W 36/06; H04B 7/024; H04W 36/30

(57) ABSTRACT

The present disclosure relates to a base station-side electronic device for a wireless communication system. The base station-side electronic device includes a processing circuitry configured to: determine a distance between the base station-side electronic device and a terminal-side electronic device; and determine, based on the distance, a Rayleigh distance for Orbital Angular Momentum (OAM) wave-based communication between the base station-side electronic device and the terminal-side electronic device, so that at least two modes of OAM waves are used for transmission between the base station-side electronic device and the terminal-side electronic device. The present disclosure also relates to a method for a base station-side electronic device for a wireless communication system and a terminal-side electronic device for a wireless communication system.

### TECHNICAL FIELD

The present disclosure relates generally to wireless communication systems, and in particular to techniques of Orbital Angular Momentum (OAM) wave-based communication.

### BACKGROUND ART

Electromagnetic waves may carry not only energy, but also momentum. Momentum may be divided into linear momentum and angular momentum, and the angular momentum may be decomposed into Spin Angular Momentum (SAM) and Orbital Angular Momentum (OAM). OAM is the result of the phase of the wave changing with respect to the azimuth angle θ around the wave's axis of propagation. This changing results in a helical phase distribution φ=1*θ of a wavefront of a vortex wave (a wave carrying OAM is referred to herein as “vortex waves” or “OAM wave”), wherein I represents an OAM mode, which refers to the number of complete phase rotations within one wavelength. In current plane wave RF communications, the transmitted beam does not have OAM, i.e., the mode 1=0, resulting in a wavefront of a plane wave.

Due to the orthogonality between different integer OAM modes, the multi-mode multiplexing of OAM waves may improve the utilization rate of communication resources. FIG. 12C shows a schematic diagram of OAM wave-based communication. In this example, the communication between the transmitter Tx and the receiver Rx is based on OAM waves, and the orthogonality between different integer OAM modes 1=0, 1, 2, 3, . . . , N may be utilized to simultaneously transmit OAM waves in orthogonal multiple modes on the same frequency resource, thereby realizing multi-mode multiplexing of OAM waves.

### Content of the Present Disclosure

One of aspects of the present disclosure relates to base station-side electronic device for a wireless communication system. According to one embodiment, the electronic device may include a processing circuitry. The processing circuitry may be configured to: determine a distance between the base station-side electronic device and a terminal-side electronic device; and determine, based on the distance, a Rayleigh distance for Orbital Angular Momentum (OAM) wave-based communication between the base station-side electronic device and the terminal-side electronic device, so that at least two modes of OAM waves are used for transmission between the base station-side electronic device and the terminal-side electronic device.

One of aspects of the present disclosure relates to a method for a base station-side electronic device for a wireless communication system. According to one embodiment, the method includes: determining a distance between the base station-side electronic device and a terminal-side electronic device; determining, based on the distance and an antenna aperture of an OAM wave antenna of the base station-side electronic device, a transmission frequency of an OAM wave-based downlink for the terminal-side electronic device; and notifying the terminal-side electronic device of information indicating the transmission frequency of the downlink.

One of aspects of the present disclosure relates to a terminal-side electronic device for a wireless communication system. According to one embodiment, the electronic device includes a processing circuitry. The processing circuitry may be configured to: receive, from a base station-side electronic device, information indicating a transmission frequency of an Orbital Angular Momentum (OAM) wave-based downlink; and receive signals on the downlink by an OAM antenna of the terminal-side electronic device on the transmission frequency of the downlink.

The foregoing summary is provided to summarize some exemplary embodiments in order to provide basic understanding of aspects of the subject matter described herein. Accordingly, the above-described features are examples only and should not be construed to narrow the scope or spirit of the subject matter described herein in any way. Other features, aspects, and advantages of the subject matter described herein will become apparent from the following detailed description described in conjunction with the accompanying drawings.

### BRIEF DESCRIPTION OF THE DRAWINGS

Better understanding of the present disclosure may be obtained when considering the following detailed description of the embodiments in conjunction with the accompanying drawings. The same or similar reference numerals are used in the drawings to denote the same or similar components. The accompanying drawings, together with the following detailed description, are incorporated in and form a part of this specification, and serve to illustrate embodiments of the present disclosure and explain principles and advantages of the present disclosure, wherein:

FIGS. 1A and 1B illustrate an exemplary base station-side electronic device according to an embodiment of the present disclosure;

FIGS. 2A and 2B illustrate an exemplary terminal-side electronic device according to an embodiment of the present disclosure;

FIGS. 3 to 6 illustrate an exemplary method for a base station-side electronic device according to an embodiment of the present disclosure;

FIGS. 7 and 8 illustrate an exemplary method for a terminal-side electronic device according to an embodiment of the present disclosure;

FIGS. 9 to 11 illustrate an interactive flowchart of an exemplary communication process according to an embodiment of the present disclosure;

FIGS. 12A and 12B illustrate radiation characteristics of OAM waves;

FIG. 12C illustrates a schematic diagram of OAM wave-based communication;

FIG. 12D illustrates transmission characteristics of an exemplary bitmap indicator according to an embodiment of the present disclosure;

FIG. 13 is a block diagram of an example structure of a personal computer as an information processing device employable in an embodiment of the present disclosure;

FIG. 14 is a block diagram illustrating a first example of a schematic configuration of a gNB to which the technology of the present disclosure may be applied;

FIG. 15 is a block diagram illustrating a second example of a schematic configuration of a gNB to which the technology of the present disclosure may be applied;

FIG. 16 is a block diagram illustrating an example of a schematic configuration of a smartphone to which the technology of the present disclosure may be applied; and

FIG. 17 is a block diagram illustrating an example of a schematic configuration of a car navigation device to which the technology of the present disclosure may be applied.

While the embodiments described in this disclosure may be susceptible to various modifications and alternative forms, specific embodiments thereof are shown by way of example in the drawings and described in detail herein. It should be understood, however, that the drawings and detailed description thereto are not to limit the embodiments to the disclosed particular forms, but on the contrary, the intention is to cover all modifications, equivalents and alternatives falling within the spirit and scope of the claims.

### EMBODIMENTS

Representative applications of aspects such as devices and methods according to the present disclosure are described below. These examples are described only to add context and to assist in understanding the described embodiments. Thus, it will be apparent to those skilled in the art that the embodiments described below may be practiced without some or all of the specific details. In other instances, well known process steps have not been described in detail to avoid unnecessarily obscuring the described embodiments. Other applications are possible and the aspects of the present disclosure are not limited to these examples.

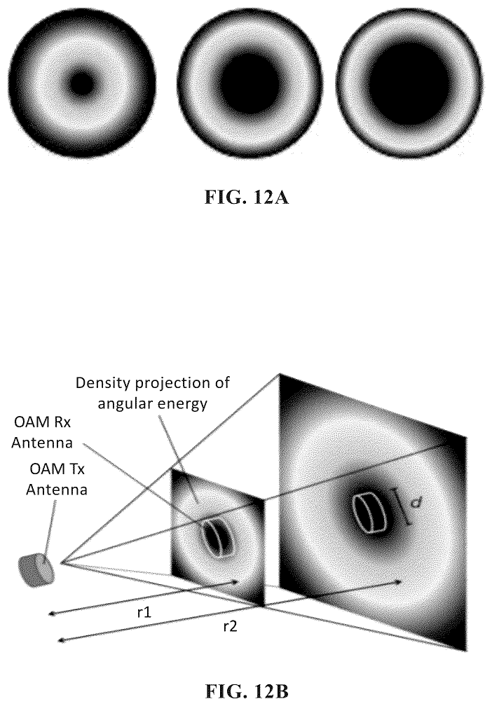

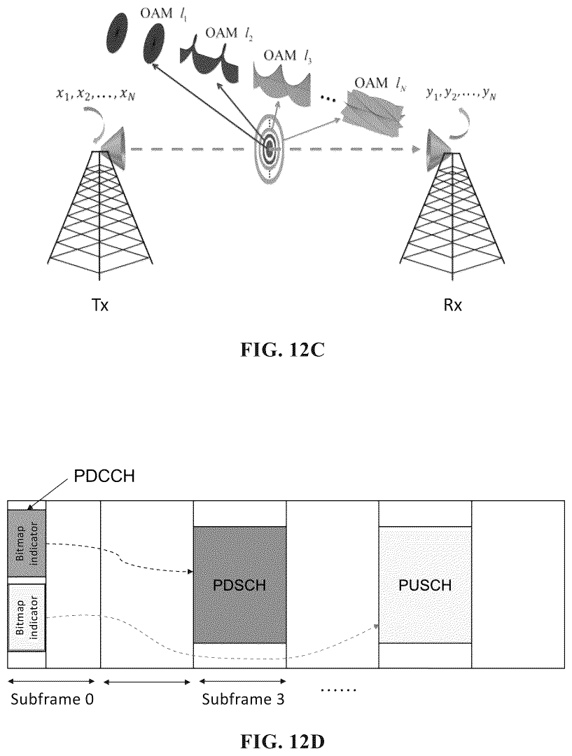

OAM waves have radiation characteristics of being hollow and divergent, and FIGS. 12A and 12B illustrate the radiation characteristic of being hollow and the radiation characteristic of being divergent of OAM waves, respectively. FIG. 12A illustrates the variation of OAM waves of different modes on a section perpendicular to the propagation direction, wherein absolute values of the modes increase from left to right. It can be seen that the OAM wave has a hollow field intensity distribution, that is, there is an empty area at the center of the beam. As the absolute value of the OAM mode is larger, the hollow area is larger. FIG. 12B illustrates the variation of the divergence angle of the OAM wave of one mode in the propagation direction, wherein the propagation distance r2 is greater than the propagation distance r1. It can be seen that the longer the transmission distance of the OAM wave, the larger the divergence angle. In summary, the larger the absolute value of the OAM mode of the OAM wave, the larger the divergence angle and the shorter the propagation distance. Therefore, after the transmission distance D exceeds the Rayleigh distance d_{R}, the signal-to-noise ratio of a high-order (with a large absolute value) mode will drop sharply. When the transmission distance D is much greater than the Rayleigh distance d_{R}, for example when D>10d_{R}, only the OAM null mode (i.e., 1=0) exists for carrying information with a practical SNR, which means that the multiplexing gain cannot be achieved. It can be seen that the Rayleigh distance d_{R} is of great significance for OAM multimode multiplexing.

The Rayleigh distance d_{R} is defined as: d_{R}=2L²/λ, wherein λ is a wavelength of an electromagnetic wave, and L represents an aperture of an antenna of a transmitting end. For example, for a Uniform Circular antenna Array (UCA), the aperture L of the antenna refers to the diameter of the circle formed by mechanical centers of respective radiating elements forming the UCA. Since λ=c/f, wherein c is a propagation speed of the electromagnetic wave and f is a frequency of the electromagnetic wave, the Rayleigh distance d_{R} may also be expressed as d_{R}=2L²f/c. It can be seen that the Rayleigh distance d_{R} is related to the antenna aperture L and the transmission frequency f. For example, the antenna aperture L for OAM wave communication is 1 m, and when the transmission frequency f is 30 GHz, its Rayleigh distance d_{R} is 200 m.

By the base station-side electronic device for a wireless communication system, the method for a base station-side electronic device for a wireless communication system, and the terminal-side electronic device for a wireless communication system according to the embodiments of the present disclosure, the Rayleigh distance of OAM wave communication is adjusted, so that a communication distance between the base station-side electronic device and the terminal-side electronic device is not greater that (or at least not much greater than) the Rayleigh distance of OAM wave-based communication, so as to realize the multimode multiplexing of OAM waves in the wireless communication system.

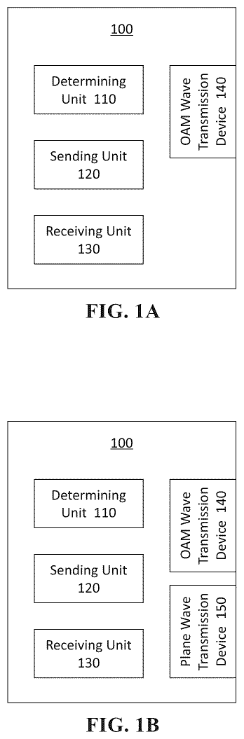

FIGS. 1A and 1B illustrate an exemplary base station-side electronic device 100 according to an embodiment of the present disclosure. The base station-side electronic device 100 may be applied in various wireless communication systems. The electronic devices 100 shown in FIGS. 1A and 1B may include various units to implement various embodiments according to the present disclosure. In the embodiment shown in FIG. 1A, the electronic device 100 may include a determining unit 110, a sending unit 120, a receiving unit 130 and an OAM wave transmission device 140. The electronic device 100 in this embodiment has only a function of OAM wave-based communication. In the embodiment shown in FIG. 1B, in addition to the above units 110 to 140, the electronic device 100 may further include a plane wave transmission device 150. The electronic device 100 in this embodiment has both the function of OAM wave-based communication and a function of plane wave-based communication. In an embodiment, the electronic device 100 may be implemented as any one of or a part of the transmitter Tx and the receiver Rx in FIG. 12C, or may be implemented as a device (such as a base station controller) or a part of the device configured to control any one of the transmitter Tx and the receiver Rx or to be otherwise related to any one of the transmitter Tx and the receiver Rx. Various operations of the base station-side electronic device described below in conjunction with FIGS. 3 to 6 and 9 to 11 may be implemented by the units 110 to 150 of the electronic device 100 or other possible units.

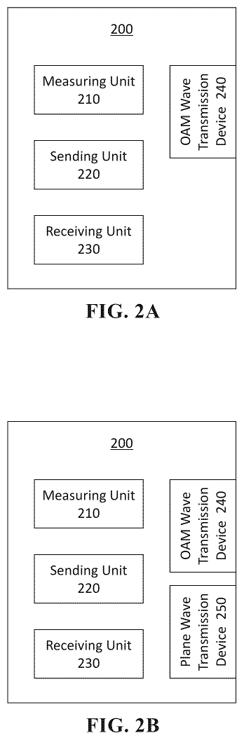

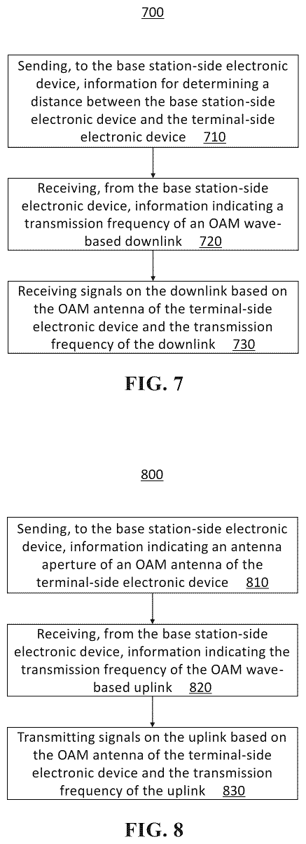

FIGS. 2A and 2B illustrate an exemplary terminal-side electronic device 200 according to an embodiment of the present disclosure. The terminal-side electronic device 200 may be applied in various wireless communication systems. The electronic device 200 shown in FIGS. 2A and 2B may include various units to implement various embodiments according to the present disclosure. In the embodiment shown in FIG. 2A, the electronic device 200 may include a measuring unit 210, a sending unit 220, a receiving unit 230 and an OAM wave transmission device 240. The electronic device 200 in this embodiment has only a function of OAM wave-based communication. In the embodiment shown in FIG. 2B, in addition to the above units 210 to 240, the electronic device 200 may further include a plane wave transmission device 250. The electronic device 200 in this embodiment has both the function of OAM wave-based communication and a function of plane wave-based communication. In an embodiment, the electronic device 200 may be implemented as any one of or a part of the transmitter Tx and the receiver Rx in FIG. 12C, or may be implemented as a device (such as a terminal controller) or a part of the device configured to control any one of the transmitter Tx and the receiver Rx or to be otherwise related to any one of the transmitter Tx and the receiver Rx. Various operations of the terminal-side electronic device described below in conjunction with FIGS. 7, 8 and 9 to 11 may be implemented by the units 210 to 250 of the electronic device 200 or other possible units.

In some embodiments, the electronic devices 100 and 200 may be implemented at a chip level, or may also be implemented at a device level by incorporating other external components. For example, each electronic device may operate as a communication device as a complete machine.

It should be noted that the above-mentioned units are only logical modules divided according to the specific functions they implement, and are not intended to limit specific implementation methods, for example, these units may be implemented in software, hardware, or a combination of software and hardware. In actual implementation, each of the above units may be implemented as an independent physical entity, or may also be implemented by a single entity (for example, a processor (CPU or DSP, etc.), an integrated circuit, etc.). Herein, a processing circuitry may refer to various implementations of a digital circuitry, an analog circuitry, or a mixed-signal (combination of analog and digital signals) circuitry that performs a function in a computing system. The processing circuitry may include, for example, circuits such as integrated circuits (ICs), application-specific integrated circuits (ASICs), portions or circuits of individual processor cores, entire processor cores, individual processors, a programmable hardware device such as field programmable gate array (FPGA), and/or a system including multiple processors.

FIG. 3 illustrates an exemplary method 300 for a base station-side electronic device according to an embodiment of the present disclosure. The example method 300 may be executed by the above-mentioned electronic device 100.

At 310, the base station-side electronic device (such as the electronic device 100) may determine (for example, through the determining unit 110) a distance D between the base station-side electronic device and the terminal-side electronic device. The base station-side electronic device may use various known methods to determine the distance D between itself and the terminal-side electronic device. In an embodiment, the terminal-side electronic device may use a global positioning system (GPS) to obtain its positioning information, and send this information (for example, through the sending unit 220) to the base station-side electronic device. The base station-side electronic device may determine the distance D between itself and the terminal-side electronic device based on its own geographic location and the GPS positioning information of the terminal-side electronic device.

At 320, the base station-side electronic device may determine (for example, through the determining unit 110), based on the distance D between the base station-side electronic device and the terminal-side electronic device, the Rayleigh distance d_{R} for OAM wave-based communication between the base station-side electronic device and the terminal-side electronic device, such that at least two modes of OAM waves may be used for transmission between the base station-side electronic device and the terminal-side electronic device. In an embodiment, the base station-side electronic device may determine, based on the distance D between the base station-side electronic device and the terminal-side electronic device, the Rayleigh distance d_{R} for OAM wave-based communication between the base station-side electronic device and the terminal-side electronic device, so that the distance D between the base station-side electronic device and the terminal-side electronic device is not greater than a times the Rayleigh distance d_{R}, that is, D≤αd_{R}, wherein 0<α≤10. In this way, the communication distance D between the base station-side electronic device and the terminal-side electronic device may be made not greater than (or at least not much greater than) the Rayleigh distance d_{R} for OAM wave-based communication, so as to realize multi-mode multiplexing of OAM waves in wireless communication systems.

At 330, the base station-side electronic device may determine (for example, through the determining unit 110), based on the determined Rayleigh distance d_{R}, a transmission frequency f for OAM wave communication between the base station-side electronic device and the terminal-side electronic device. In an embodiment, the base station-side electronic device may determine, based on the determined Rayleigh distance d_{R} and an antenna aperture L_{BS} of an OAM wave antenna of the base station-side electronic device, the transmission frequency f_{DL} of the OAM wave-based downlink for the terminal-side electronic device, for example, according to a formula of cd_{R}/(2L_{BS}²)=f_{DL} . . . . Then, the base station-side electronic device may notify (for example, through the sending unit 120) the terminal-side electronic device of the information indicating the transmission frequency f_{DL} of the downlink, and perform OAM wave-based communication (for example, through the sending unit 120) with the terminal-side electronic device on the downlink on the transmission frequency f_{DL} of the downlink. In an embodiment, the base station-side electronic device may receive (for example, through the receiving unit 130), from the terminal electronic device, information indicating the antenna aperture L_{UE} of the OAM wave antenna of the terminal-side electronic device, and determine, based on the determined Rayleigh distance d_{R} and the antenna aperture L_{UE} of the OAM wave antenna of the terminal-side electronic device, the transmission frequency f_{UL} of the OAM wave-based uplink for the terminal-side electronic device, for example, according to a formula of cd_{R}/(2L_{UE}²)=f_{UL} . . . . Then, the base station-side electronic device may notify (for example, through the sending unit 120) the terminal-side electronic device of information indicating the transmission frequency f_{UL} of the uplink, and perform OAM wave-based communication (for example, through the receiving unit 130) with the terminal-side electronic device on the uplink on the transmission frequency f_{UL} of the uplink.

In an embodiment wherein the base station-side electronic device 100 only has the function of OAM wave-based communication as shown in FIG. 1A, the determined transmission frequency f (including the transmission frequency f_{DL} of the downlink and/or the transmission frequency f_{UL} of the uplink) for OAM wave communication between the base station-side electronic device and the terminal-side electronic device may be notified to the terminal-side electronic device via the OAM wave-based communication. In an embodiment where the base station-side electronic device 100 has both the function of OAM wave-based communication and the function of plane wave-based communication as shown in FIG. 1B, the determined transmission frequency f (including the transmission frequency f_{DL} of the downlink and/or the transmission frequency f_{UL} of the uplink) for OAM wave communication between the base station-side electronic device and the terminal-side electronic device may be notified to the terminal-side electronic device via the OAM wave-based communication or the plane wave-based communication. It should be understood that the above notification may be implemented with a physical layer (L1) signaling, or may also be implemented with a higher layer (L2/L3) signaling.

In an embodiment, the terminal-side electronic device may include a first terminal-side electronic device and a second terminal-side electronic device. A communication distance between the first terminal-side electronic device and the base station-side electronic device is a first distance, and a communication distance between the second terminal-side electronic device and the base station-side electronic device is a second distance. The base station-side electronic device determines a first transmission frequency of OAM wave communication with the first terminal-side electronic device and a second transmission frequency of OAM wave communication with the second terminal-side electronic device according to the method described above, and notifies the first terminal-side electronic device and the second terminal-side electronic device of information indicating the first transmission frequency and information indicating the second transmission frequency, respectively. In this embodiment, it is assumed that the first distance is greater than the second distance, that is, the first terminal-side electronic device is farther from the base station-side electronic device, and the second terminal-side electronic device is closer to the base station-side electronic device. In this case, the first transmission frequency may be higher than the second transmission frequency, both determined by the base station-side electronic device according to the method described above, that is, a higher-frequency transmission resource is allocated to a terminal farther from the base station, and a lower-frequency transmission resource is allocated to a terminal closer to the base station.

In an embodiment, the terminal-side electronic device may move from a first location to a second location during a process of communicating with the base station-side electronic device. A communication distance between the first location and the base station-side electronic device is the first distance, and a communication distance between the second location and the base station-side electronic device is the second distance. The base station-side electronic device determines to use the first transmission frequency of OAM wave communication with the terminal-side electronic device at the first location and to use the second transmission frequency of OAM wave communication with the terminal-side electronic device at the second location according to the method described above, and notifies the terminal-side electronic device of information indicating the first transmission frequency and information indicating the second transmission frequency at corresponding timings respectively. In this embodiment, it is assumed that the first distance is greater than the second distance, that is, the terminal-side electronic device moves from a position farther from the base station-side electronic device to a position closer to the base station-side electronic device. In this case, the first transmission frequency may be higher than the second transmission frequency, both determined by the base station-side electronic device according to the method described above, that is, a higher-frequency transmission resource may be allocated to the terminal when the terminal is farther from the base station, and a lower-frequency transmission resource may be allocated to the terminal when the terminal is closer to the base station.

In current communication systems (such as 4G/5G communication systems), a resource block (RB) is a basic unit of resource allocation. An RB consists of adjacent subcarriers of all OFDM symbols in one slot. In an embodiment, in order to be compatible with current communication systems, frequency allocation for OAM wave communication may support being performed in units of RB. After the base station-side electronic device determines the transmission frequency f (including the transmission frequency f_{DL} of the downlink and/or the transmission frequency f_{UL} of the uplink) for OAM wave communication between itself and the terminal-side electronic device, the base station-side electronic device may accordingly determine the RBs (including the RBs for the downlink and/or the RBs for the uplink) corresponding to the transmission frequency f allocated to the terminal-side electronic device, and may notify the terminal-side electronic device of information indicating the allocated RBs.

With the application of millimeter-wave and terahertz frequency bands in communication systems, the available transmission bandwidth will increase significantly. In addition, with the expansion of service types, data traffic of some data services may require more RBs (for example, tens of thousands of subcarriers) at the same time, which may bring a greater burden to baseband signal processing. In an embodiment, a concept of a frequency block (FB) may be introduced to divide the available bandwidth into different FBs with different carrier frequencies. In order to be compatible with the 4G/5G communication system, frequency resources allocation may still be performed in units of RB in the frequency band used by the current 4G/5G communication system, and may be performed in units of FB in a frequency band higher than the frequency band used by the 4G/5G communication system (such as millimeter wave frequency band, terahertz frequency band, etc.).

The unit of FB may be variable. For example, for a frequency band below 6 GHz, 180 kHz may be a basic unit of the FB for resource allocation; and for a terahertz frequency band, 1 GHz may be a basic unit of the FB for resource allocation. In the 4G/5G communication systems, an interval between adjacent subcarriers is 15 kHz. In order to be compatible with the 4G/5G communication systems and to simplify the calculation of an electronic device, an interval of subcarriers of the FB may be determined by scaling the basic subcarrier interval of 15 kHz in the 4G/5G communication systems by integer multiples, such as 15 kHz*2ⁿ (n is a non-negative integer). In terahertz frequency band communication, a new Numerology may also be defined. For example, the size of the FB may be obtained by scaling the size of 180 KHz of the RB by integer multiples, such as 180 KHz*2ⁿ. Since the frequency resources in the terahertz frequency band are abundant, the value of n may be greater than or equal to 8, as shown in Table 1.

TABLE 1
Example of FB division in terahertz frequency band

| n | 8 | 10 | 12 | 13 | 14 |
|---|---|---|---|---|---|
| FB | 46 MHz | 184 MHz | 737 MHz | 1.47 GHz | 2.94 GHz |

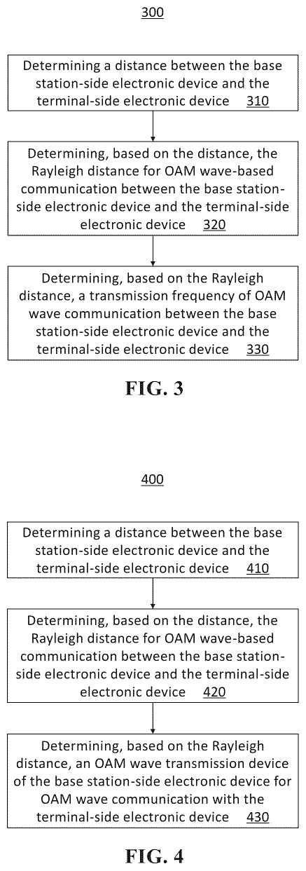

FIG. 4 illustrates an exemplary method 400 for a base station-side electronic device according to an embodiment of the present disclosure. The example method 400 may be executed by the above-mentioned electronic device 100.

At 410, the base station-side electronic device (such as the electronic device 100) may determine (for example, through the determining unit 110) a distance D between the base station-side electronic device and a terminal-side electronic device. Since an operation of 410 is similar to that of 310, its detailed description is omitted. At 420, the base station-side electronic device may determine (for example, through the determining unit 110), based on the distance D between the base station-side electronic device and the terminal-side electronic device, the Rayleigh distance d_{R} for OAM wave-based communication between the base station-side electronic device and the terminal-side electronic device, such that at least two modes of OAM waves may be used for transmission between the base station-side electronic device and the terminal-side electronic device. Since an operation of 420 is similar to that of 320, its detailed description is omitted.

At 430, the base station-side electronic device may determine (for example, through the determining unit 110), based on the determined Rayleigh distance d_{R}, an OAM wave transmission device for OAM wave communication between the base station-side electronic device and the terminal-side electronic device. In an embodiment, the base station-side electronic device may determine, based on the Rayleigh distance d_{R} and the transmission frequency f_{DL} of an OAM wave-based downlink between the base station-side electronic device and the terminal-side electronic device, an antenna aperture L_{BS} of an OAM wave antenna for the downlink, for example, according to a formula of cd_{R}/(2L_{BS}²)=f_{DL}, and determine an OAM wave antenna with the antenna aperture L_{BS} of the base station-side electronic device as the OAM wave transmission device for the OAM wave-based downlink between the base station-side electronic device and the terminal-side electronic device. Signals for the terminal-side electronic device are transmitted on the downlink by the determined OAM wave transmission device for the OAM wave-based downlink between the base station-side electronic device and the terminal-side electronic device.

In an embodiment, the OAM wave transmission device (for example, the OAM wave transmission device 140) of the base station-side electronic device includes a first OAM wave antenna and a second OAM wave antenna. The first OAM wave antenna has a first antenna aperture and the second OAM wave antenna has a second antenna aperture. The terminal-side electronic device may include a first terminal-side electronic device and a second terminal-side electronic device. A communication distance between the first terminal-side electronic device and the base station-side electronic device is a first distance, and a communication distance between the second terminal-side electronic device and the base station-side electronic device is a second distance. The base station-side electronic device determines to use the first OAM wave antenna for OAM wave communication with the first terminal-side electronic device and to use the second OAM wave antenna for OAM wave communication with the second terminal-side electronic device, according to the method described above. In this embodiment, it is assumed that the first distance is greater than the second distance, that is, the first terminal-side electronic device is farther from the base station-side electronic device, and the second terminal-side electronic device is closer to the base station-side electronic device. In this case, the first antenna aperture of the first OAM wave antenna may be larger than the second antenna aperture of the second OAM wave antenna, both determined by the base station-side electronic device according to the method described above, that is, an OAM wave antenna with a larger antenna aperture is used for a terminal farther from the base station, and an OAM wave antenna with a smaller antenna aperture is used for a terminal closer to the base station.

In an embodiment, the OAM wave transmission device (for example, the OAM wave transmission device 140) of the base station-side electronic device includes a first OAM wave antenna and a second OAM wave antenna. The first OAM wave antenna has a first antenna aperture and the second OAM wave antenna has a second antenna aperture. The terminal-side electronic device may move from a first location to a second location during a process of communicating with the base station-side electronic device. A communication distance between the first location and the base station-side electronic device is a first distance, and a communication distance between the second location and the base station-side electronic device is a second distance. The base station-side electronic device determines to use the first OAM wave antenna for OAM wave communication with the terminal-side electronic device at the first location, and to use the second OAM wave antenna for OAM wave communication with the terminal-side electronic device at the second location, according to the method described above. In this embodiment, it is assumed that the first distance is greater than the second distance, that is, the terminal-side electronic device moves from a position farther from the base station-side electronic device to a position closer to the base station-side electronic device. In this case, the first antenna aperture of the first OAM wave antenna may be larger than the second antenna aperture of the second OAM wave antenna, both determined by the base station-side electronic device according to the method described above, that is, an OAM wave antenna with a larger antenna aperture may be used for the terminal when the terminal is farther from the base station, and an OAM wave antenna with a smaller antenna aperture may be used for the terminal when the terminal is closer to the base station.

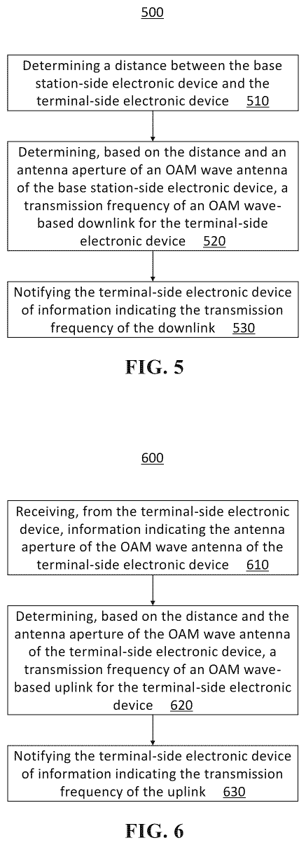

In some embodiments, the base station-side electronic device may not explicitly determine the Rayleigh distance d_{R}, such as in the methods described below in conjunction with FIGS. 5 and 6. It should be understood that in these methods, although the transmission frequency f for communication between the base station-side electronic device and the terminal-side electronic device is determined directly based on the formula according to the communication distance D therebetween, the Rayleigh distance d_{R} for OAM wave communication therebetween is implicitly determined in the principles.

FIG. 5 illustrates an exemplary method 500 for a base station-side electronic device according to an embodiment of the present disclosure. The example method 500 may be executed by the above-mentioned electronic device 100.

At 510, the base station-side electronic device (such as the electronic device 100) may determine (for example, through the determining unit 110) a distance D between the base station-side electronic device and the terminal-side electronic device. Since an operation of 510 is similar to that of 310, its detailed description is omitted.

At 520, the base station-side electronic device may determine (for example, according to a formula of cD/(2αL_{BS}²)≤f_{DL}), based on the distance D and an antenna aperture L_{BS} of an OAM wave antenna of the base station-side electronic device, the transmission frequency f_{DL} of an OAM wave-based downlink for the terminal-side electronic device.

At 530, the base station-side electronic device may notify (for example, through the sending unit 120) the terminal-side electronic device of information indicating the transmission frequency f_{DL} of the downlink, and may subsequently perform (for example, through the sending unit 120) OAM wave-based communication with the terminal-side electronic device on the downlink on the transmission frequency f_{DL} of the downlink.

FIG. 6 illustrates an exemplary method 600 for a base station-side electronic device according to an embodiment of the present disclosure. The example method 600 may be executed by the above-mentioned electronic device 100.

At 610, the base station-side electronic device may receive (for example, through the receiving unit 130), from the terminal-side electronic device, information indicating the antenna aperture Lux of the OAM wave antenna of the terminal-side electronic device. In addition, the base station-side electronic device may also determine a distance D between the base station-side electronic device and the terminal-side electronic device as described above.

At 620, the base station-side electronic device may determine (for example, according to a formula of cD/(2αL_{UE}²)≤f_{UL}), based on the distance D and the antenna aperture L_{UE} of the OAM wave antenna of the terminal-side electronic device, the transmission frequency f_{UL} of an OAM wave-based uplink for the terminal-side electronic device.

At 630, the base station-side electronic device may notify (for example, through the sending unit 120) the terminal-side electronic device of information indicating the transmission frequency f_{UL} of the uplink, and may subsequently perform (for example, through the receiving unit 130) OAM wave-based communication with the terminal-side electronic device on the uplink on the transmission frequency f_{UL} of the uplink.

FIG. 7 illustrates an exemplary method 700 for a terminal-side electronic device according to an embodiment of the present disclosure. The example method 700 may be executed by the above-mentioned electronic device 200.

At 710, the terminal-side electronic device (for example, the electronic device 200) may send (for example, through the sending unit 220), to the base station-side electronic device, information for determining a distance between the base station-side electronic device and the terminal-side electronic device. In an embodiment, the terminal-side electronic device may use GPS to obtain its own positioning information, and send this information to the base station-side electronic device. The base station-side electronic device may determine the distance D between itself and the terminal-side electronic device based on its own geographic location and the GPS positioning information of the terminal-side electronic device.

At 720, the terminal-side electronic device may receive (for example, through the receiving unit 230), from the base station-side electronic device, information indicating the transmission frequency f_{DL} of an OAM wave-based downlink.

At 730, the terminal-side electronic device may receive signals from the base station-side electronic device on the downlink based on the OAM antenna of the terminal-side electronic device and the transmission frequency for, of the downlink.

FIG. 8 illustrates an exemplary method 800 for a terminal-side electronic device according to an embodiment of the present disclosure. The example method 800 may be executed by the above-mentioned electronic device 200.

At 810, the terminal-side electronic device (for example, the electronic device 200) may send (for example, through the sending unit 220), to the base station-side electronic device, information indicating the antenna aperture L_{UE} of the OAM antenna of the terminal-side electronic device, so that the base station-side electronic device may determine the transmission frequency f_{UL} of the OAM wave-based uplink between the base station-side electronic device and the terminal-side electronic device.

At 820, the terminal-side electronic device may receive (for example, through the receiving unit 230), from the base station-side electronic device, information indicating the transmission frequency f_{UL} of the OAM wave-based uplink.

At 820, the terminal-side electronic device may transmit (for example, through the sending unit 220) signals on the uplink to the base station-side electronic device based on the OAM antenna of the terminal-side electronic device and the transmission frequency f_{UL} of the uplink.

Some embodiments of the present disclosure have been described above with reference to FIGS. 3 to 8. In these embodiments, by adjusting the Rayleigh distance of OAM wave communication, a communication distance between the base station-side electronic device and the terminal-side electronic device is not greater than (or at least not much greater than) the Rayleigh distance of OAM wave-based communication, so as to realize the multi-mode multiplexing of OAM waves in wireless communication systems.

When performing OAM wave-based communication, in some areas of a cell (such as the edge of the cell) or in some specific environments (such as scenes with very rich scattering), there may be a case that the signal-to-noise ratio of signals received by the terminal is lower than a target value. In the embodiments of the present disclosure described next, base station resource selection related to OAM wave communication is provided to ensure reliable communication between the base station and the terminal.

The study found that OAM wave-based communication usually works better in wireless channels with a line of sight (LOS) path or a strong LOS path, while when there is no strong LOS path and the surrounding scattering is rich, the performance of OAM wave-based communication will drop sharply. In this case, if the area is also covered by a conventional multiple-input multiple-output (MIMO) transmission device, it may be a better choice to switch to the conventional MIMO transmission device. Since a large number of random scattering paths make elements in a channel matrix close to Gaussian variables, the rank of the matrix is increased, which is beneficial to MIMO transmission. An OAM wave transmission device and a plane wave transmission device available for switching between each other may be different transmission devices in the same base station, or may be different transmission devices of different base stations. It should be understood that the different base stations mentioned herein may be different base stations at different locations (e.g., on different signal towers), or different base stations at the same location (e.g., on the same signal tower).

In some cases, the base station or the terminal may have both an OAM wave transmission device (such as an OAM wave antenna) and a plane wave transmission device (such as a MIMO antenna for plane wave), so that the base station and the terminal may communicate with each other by OAM wave transmission devices in a transmission environment with a LOS path, and may communicate with each other by plane wave transmission devices or by both OAM wave transmission devices and plane wave transmission devices in a transmission environment having no LOS path.

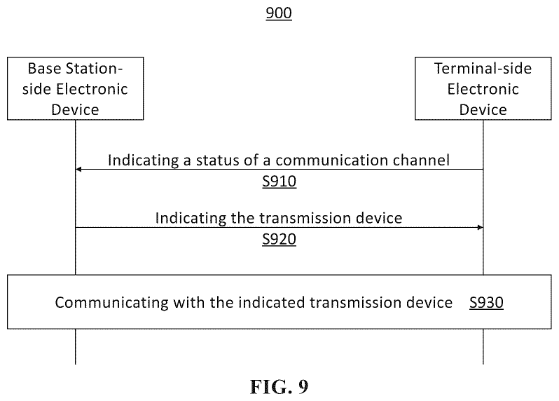

FIG. 9 illustrates an interactive flowchart of an exemplary communication process 900 according to an embodiment of the present disclosure. The exemplary communication process 900 may be performed by electronic devices 100 and 200 described above.

The base station-side electronic device (such as the electronic device 100) receives, from the terminal-side electronic device (such as the electronic device 200), information indicating a status of a communication channel between the base station-side electronic device and the terminal-side electronic device (S910). The information on the status of the communication channel between the base station-side electronic device and the terminal-side electronic device may be obtained through measurement (for example, through the measuring unit 210) by the terminal-side electronic device. The base station-side electronic device may determine (for example, through the determining unit 110), according to the status of the communication channel, to use the OAM wave transmission device (such as the OAM wave transmission device 140) and/or the plane wave transmission device (such as the plane wave transmission device 150) of the base station-side electronic device for communication with the terminal-side electronic device. The base station-side electronic device indicates the determined transmission device (for example, through the sending unit 120) to the terminal-side electronic device (S920). The terminal-side electronic device receives (for example, through the receiving unit 230) the indication, and communicates with the base station-side electronic device with the indicated transmission device (S930).

In an embodiment, in response to the status of the communication channel meeting a first condition, the base station-side electronic device may determine to use the OAM wave transmission device of the base station-side electronic device to communicate with the terminal-side electronic device. Correspondingly, the terminal-side electronic device also needs to use an OAM wave transmission device (for example, the OAM wave transmission device 240) of the terminal-side electronic device to communicate with the base station-side electronic device. In response to the status of the communication channel meeting a second condition, the base station-side electronic device may determine to use the plane wave transmission device of the base station-side electronic device to communicate with the terminal-side electronic device. Correspondingly, the terminal-side electronic device also needs to use a plane wave transmission device (for example, the plane wave transmission device 250) of the terminal-side electronic device to communicate with the base station-side electronic device. In response to the status of the communication channel meeting a third condition, the base station-side electronic device may determine to use both the OAM wave transmission device and the plane wave transmission device of the base station-side electronic device to communicate with the terminal-side electronic device. Correspondingly, the terminal-side electronic device also needs to use both the OAM wave transmission device and the plane wave transmission device of the terminal-side electronic device to communicate with the base station-side electronic device.

In an embodiment, the status of the communication channel is a multipath status of the communication channel. In response to the multipath status of the communication channel being that there is an LOS path, the base station-side electronic device may determine to use the OAM wave transmission device to communicate with the terminal-side electronic device. In response to the multipath status of the communication channel being that there is no LOS path and energy of a non-line of sight (NLOS) path is greater than a threshold value, the base station-side electronic device may determine to use a MIMO plane wave transmission device of the base station-side electronic device to communicate with the terminal-side electronic device.

The Rician K-factor may be used to indicate the multipath status of the communication channel, and it may be used to identify the ratio of the main signal power (generally LOS path signal power) to the variance of the multipath component. The terminal may calculate the Rician K-factor and the received SNR with a received pilot signal. For example, the Rician K-factor may be estimated by the following formula:

$$K = - \frac{- 2 {μ}_{2}^{2} + {μ}_{4} - {μ}_{2} \sqrt{2 {μ}_{2}^{2} - {μ}_{4}}}{{μ}_{2}^{2} - {μ}_{4}} ,$$

$$wherein {μ}_{m} = \frac{1}{N} {\sum }_{n = 0}^{N - 1} {r}^{m} ( n )$$

represents the m^{th} moment of Rician distribution, there are N samples, and r(n) represents the envelope of channel estimation.

In some cases, for example, when the terminal moves to the edge of the cell, the quality of the communication channel between the base station-side electronic device and the terminal-side electronic device is lower than a threshold, for example, the signal-to-noise ratio of signals received by the terminal-side electronic device is lower than a target value. In this case, the base station-side electronic device may select one or more other base stations in its vicinity to implement coordinated multiple points technology to improve communication quality. Other base stations for performing coordinated multiple points may use OAM wave transmission devices to cooperate with the base station-side electronic device using an OAM wave transmission device, or may use plane wave transmission devices to cooperate with the base station-side electronic device using an OAM wave transmission device. It should be understood that in the latter case, the terminal-side electronic device needs to have the functions of both OAM wave communication and plane wave communication.

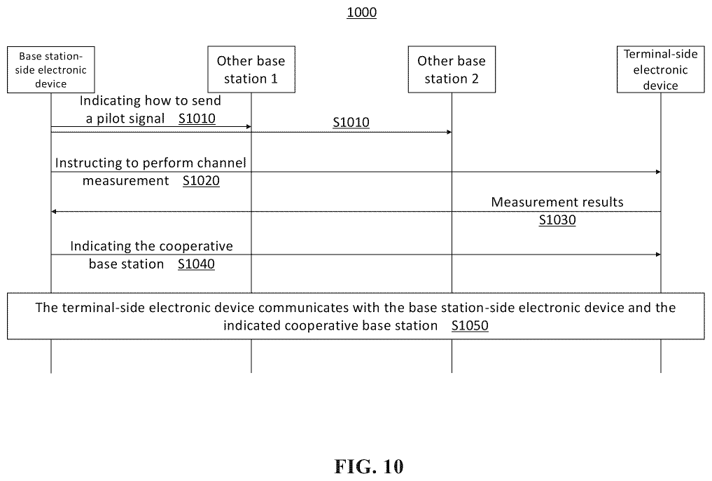

FIG. 10 illustrates an interactive flowchart of an exemplary communication process 1000 according to an embodiment of the present disclosure. The exemplary communication process 1000 may be performed by electronic devices 100 and 200 described above. The communication process 1000 may be started based on a request of the terminal-side electronic device, or may be started autonomously by the base station-side electronic device according to the measurement result of the communication channel reported by the terminal-side electronic device.

The base station-side electronic device (such as the electronic device 100, which may be referred to as a master base station in these embodiments) may select, from its neighboring base stations, other base stations (which may be referred to as secondary base stations in these embodiments) that the terminal-side electronic device may be able to measure (for example, the terminal-side electronic device may be able to receive a pilot signal of the base station). The secondary base station may be a base station that uses an OAM wave transmission device for communication, and may also be a base station that uses a plane wave transmission device (such as a MIMO transmission device) for communication.

The master base station notifies (for example, through an Xn interface) the selected secondary base station (i.e., other base station 1, other base station 2) of how to send a pilot signal (S1010), for example, to send based on which slot/symbol or orthogonal code, etc. In addition, the master base station instructs the terminal-side electronic device (for example, the electronic device 200) to perform channel measurement (S1020). The master base station and the secondary base station send pilot signals to the terminal-side electronic device in a manner notified by the master base station. The terminal-side electronic device performs downlink channel estimation on the pilot signals sent by the master base station and the secondary base station respectively, and feeds back the measurement results, that is, channel estimation information about the master base station and the secondary base station, to the master base station (S1030). The master base station selects one or more of the measured secondary base stations as the cooperative base stations according to the measurement result fed back by the terminal-side electronic device. Afterwards, the master base station shares (for example, through the Xn interface) channel information with the selected cooperative base station, and indicates information on the cooperative base station to the terminal-side electronic device (S1040). The terminal-side electronic device communicates with the master base station and one or more cooperative base stations according to the indicated contents (S1050). After S1040 and before S1050, each base station and terminal-side electronic device may wait several slots as a lag time. The set lag time may be used for preparation work, such as calculation of precoding matrix and data exchange between base stations. The precoding matrix of each base station is calculated by the master base station according to the corresponding downlink channel estimation result, and the master base station notifies the corresponding cooperative base station of the calculation result.

In S1020, the master base station may instruct the terminal-side electronic device to perform channel measurement through a bitmap indicator. In a specific example, the bitmap indicator may be composed of two parts. The first part (such as one or more Most Significant Bits (MSBs)) may be used to indicate a base station that performs OAM wave-based communication (which is referred to as an OAM base station), and the second part (such as one or more Least Significant Bits (LSBs)) may indicate a base station that performs plane wave MIMO-based communication (which is referred to as a MIMO base station). The size (that is, the number of bits) of the bitmap indicator is set by a network or an upper layer, and the sizes of the first part and the second part may be the same or different. In the bitmap indicator, 1 indicates that a base station corresponding to this bit is to be measured, and 0 indicates that a base station corresponding to this bit is not to be measured.

The correspondence between the bits in the bitmap indicator and base stations may be distinguished by slots/symbols or orthogonal codes. When the bitmap indicator uses slots/symbols to distinguish base stations, the master base station appoints in advance through the Xn interface with the secondary base station about the slots for sending pilots, which correspond to the positions of the bitmap indicator one-to-one. Table 2 is a specific example of a bitmap indicator for distinguishing base stations by (time) slots Ts. In this example, the master base station sends the bitmap indicator to indicate that there are three pilot signals to be measured by the terminal-side electronic device, which are pilot signals sent at Ts1, Ts4 and Ts6 respectively. Therefore, the terminal-side electronic device only needs to perform measurements in these three slots Ts1, Ts4 and Ts6. Among them, the pilot signal of Ts1 may come from the master base station, the pilot signal of Ts4 may come from a secondary base station (such as other base station 1) that performs OAM wave-based communication, and the pilot signal of Ts6 may come from a secondary base station (such as other base stations 2) that performs plane wave MIMO-based communication. In fact, the terminal-side electronic device may not know the corresponding relationship between the pilot signals and the base stations, and may only need to perform measurement at the Ts indicated by the bitmap indicator and then report the measurement result to the master base station accordingly. In the example in Table 2, when the bitmap indicator uses slots to distinguish base stations, other reception parameters of each base station, such as frequency, codeword, etc., may be consistent with those of the master base station, so the master base station does not need to notify the terminal-side electronic device of these information, thereby simplifying the processing flow.

TABLE 2
Example of a bitmap indicator distinguishing base stations by slots

| OAM base station | | | | MIMO base station | | | |
|---|---|---|---|---|---|---|---|
| 1 | 0 | 0 | 1 | 0 | 1 | 0 | 0 |
| Ts1 | Ts2 | Ts3 | Ts4 | Ts5 | Ts6 | Ts7 | Ts8 |

When the bitmap indicator uses the orthogonal code to distinguish the base stations, the master base station appoints in advance through the Xn interface with the secondary base station about the orthogonal codes for sending pilots, which correspond to the positions of the bitmap indicator one by one. Table 3 is a specific example of a bitmap indicator using orthogonal codes to distinguish base stations. In this example, the master base station sends the bitmap indicator to indicate that there are three pilot signals to be measured by the terminal-side electronic device, which are pilot signals sent using orthogonal codeword 1, codeword 4, and codeword 6, respectively. Therefore, the terminal-side electronic device only needs to perform measurement by using the three orthogonal codewords 1, 4 and 6. Each base station and the terminal-side electronic device store a codebook of matching orthogonal codewords. The base station transmits according to the codeword index in the codebook, and the terminal-side electronic device receives according to the codeword index in the codebook. Among them, the pilot signal using codeword 1 may come from the master base station, the pilot signal using codeword 4 may come from a secondary base station (such as other base station 1) that performs OAM wave-based communication, and the pilot signal using codeword 6 may come from a secondary base station (such as other base stations 2) that perform plane wave MIMO-based communication. In fact, the terminal-side electronic device may not know the corresponding relationship between the pilot signals and the base stations, and may only need to perform measurement by using the codeword indicated by the bitmap indicator and then report the measurement result to the master base station accordingly. In the example in Table 3, when the bitmap indicator uses orthogonal codewords to distinguish base stations, other reception parameters of each base station, such as frequency, slots, etc., may be consistent with those of the master base station, so the master base station does not need to notify the terminal-side electronic device of these information, thereby simplifying the processing flow.

TABLE 3
Examples of a bitmap indicator distinguishing base stations by orthogonal codes

| OAM base station | | | | MIMO base station | | | |
|---|---|---|---|---|---|---|---|
| 1 | 0 | 0 | 1 | 0 | 1 | 0 | 0 |
| Codeword 1 | Codeword 2 | Codeword 3 | Codeword 4 | Codeword 5 | Codeword 6 | Codeword 7 | Codeword 8 |

At S1040, the master base station may also use the bitmap indicator to indicate information of cooperative base stations to the terminal-side electronic device. When indicating the cooperative base stations, different bits in the bitmap indicator may be used to distinguish the precoding matrices that should be used by the terminal-side electronic device. Table 4 shows a specific example of a bitmap indicator that indicates cooperative base stations. The master base station indicates, through the bitmap indicator, the terminal-side electronic device that the precoding matrices 1 and 4 of OAM wave communication will be used to perform coordinated multi-point communication. Each base station and the terminal-side electronic device store codebooks of matching precoding matrices. The master base station transmits signals with precoding matrix 1, the secondary base station transmits signals with precoding matrix 4, and terminal-side electronic device receives the signals with precoding matrices 1 and 4. In fact, the terminal-side electronic device may not know the corresponding relationship between the precoding matrices and the base stations, and may only need to perform communication by using the precoding matrix indicated by the bitmap indicator.

TABLE 4
Example of a bitmap indicator indicating cooperative base stations

| OAM base station | | | | MIMO base station | | | |
|---|---|---|---|---|---|---|---|
| 1 | 0 | 0 | 1 | 0 | 0 | 0 | 0 |
| ma- | Ma- | Ma- | Ma- | ma- | Ma- | Ma- | Ma- |
| trix | trix | trix | trix | trix | trix | trix | trix |
| 1 | 2 | 3 | 4 | 1 | 2 | 3 | 4 |

Bitmap indicators may be transmitted in a physical layer (L1) signaling or higher layer (L2/L3) signaling. In the specific example shown in FIG. 12D, the bitmap indicator is transmitted to the terminal-side electronic device on the physical downlink control channel (PDCCH). Since the uplink and downlink transmission resources may be asymmetrical, the uplink transmission (such as the physical uplink shared channel PUSCH) and the downlink transmission (such as the physical downlink shared channel PDSCH) may be indicated by different bitmap indicators.

In coordinated multi-point communication between multiple OAM base stations, a joint transmission technique may be used in the downlink. Each OAM base station may send the same data to the terminal-side electronic device, but may use different precoding matrices. The used precoding matrix depends on the feedback of the terminal-side electronic device for the channel measurement results (for example, equivalent channel matrix) for each OAM base station.

In a specific example, two OAM base stations using UCA cooperate, and information y received by the terminal-side electronic device is as follows:

$$y = F {H}_{1} {F}^{H} {W}_{1} x + F {H}_{2} {F}^{H} {W}_{2} x + n$$

wherein x is information sent by the base station; F^{H} is an IDFT matrix, which is used for UCA to form a vortex wave; F is a DFT matrix, which is used for UCA to unwind a vortex wave; FH₁F^{H}, FH₂F^{H} are the equivalent channels corresponding to an OAM base station 1 and an OAM base station 2 respectively; W₁, W₂ are precoding matrices corresponding to the OAM base station 1 and the OAM base station 2, respectively; n is noise. If the codebook-based precoding technology is adopted, the terminal-side electronic device is required to feedback (for example, on the physical uplink control channel PUCCH) the mode number and the precoding matrix index. If other precoding techniques are adopted, the parameters of an equivalent channel may be fed back by the terminal-side electronic device, for example, on the PUSCH.

If the terminal-side electronic device receives by adopting the maximum ratio transmission (MRT) method, the corresponding precoding matrices W₁, W₂ and the result y (that is, the information received by the terminal-side electronic device) are as follows:

$${W}_{1} = [ \begin{matrix}{h}_{1 , 1}^{*} & 0 & … & 0 \\ 0 & {h}_{1 , 2}^{*} & ⋱ & ⋮ \\ ⋮ & ⋱ & ⋱ & 0 \\ 0 & … & 0 & {h}_{1 , 4}^{*}\end{matrix} ] , {W}_{2} = [ \begin{matrix}{h}_{2 , 1}^{*} & 0 & … & 0 \\ 0 & {h}_{2 , 2}^{*} & ⋱ & ⋮ \\ ⋮ & ⋱ & ⋱ & 0 \\ 0 & … & 0 & {h}_{2 , 4}^{*}\end{matrix} ] , \\ y = [ \begin{matrix}( {\vert {h}_{1 , 1} \vert}^{2} + {\vert {h}_{2 , 1} \vert}^{2} ) {x}_{1} \\ ( {\vert {h}_{1 , 2} \vert}^{2} + {\vert {h}_{2 , 2} \vert}^{2} ) {x}_{2} \\ ( {\vert {h}_{1 , 3} \vert}^{2} + {\vert {h}_{2 , 3} \vert}^{2} ) {x}_{3} \\ ( {\vert {h}_{1 , 4} \vert}^{2} + {\vert {h}_{2 , 4} \vert}^{2} ) {x}_{4}\end{matrix} ] .$$

In coordinated multi-point communication between multiple OAM base stations, a joint processing technique may be used in the uplink. For uplink data transmission, multiple OAM base stations jointly process signals sent by the same terminal-side electronic device. For example, two OAM base stations using UCA cooperate, information received by the OAM base station 1 is: y₁=R₁FH₁F^{H}x+n, and information received by the OAM base station 2 is: y₂=R₂FH₂F^{H}x+n.

If multiple OAM base stations receive by adopting the maximum ratio combining (MRC) method, the conjugates R₁, R₂ of the channel matrices estimated by the base station and the result y received by the base station are as follows:

$${R}_{1} = [ \begin{matrix}{h}_{1 , 1}^{*} & 0 & … & 0 \\ 0 & {h}_{1 , 2}^{*} & ⋱ & ⋮ \\ ⋮ & ⋱ & ⋱ & 0 \\ 0 & … & 0 & {h}_{1 , 4}^{*}\end{matrix} ] , {R}_{2} = [ \begin{matrix}{h}_{2 , 1}^{*} & 0 & … & 0 \\ 0 & {h}_{2 , 2}^{*} & ⋱ & ⋮ \\ ⋮ & ⋱ & ⋱ & 0 \\ 0 & … & 0 & {h}_{2 , 4}^{*}\end{matrix} ] , \\ y = [ \begin{matrix}( {\vert {h}_{1 , 1} \vert}^{2} + {\vert {h}_{2 , 1} \vert}^{2} ) {x}_{1} \\ ( {\vert {h}_{1 , 2} \vert}^{2} + {\vert {h}_{2 , 2} \vert}^{2} ) {x}_{2} \\ ( {\vert {h}_{1 , 3} \vert}^{2} + {\vert {h}_{2 , 3} \vert}^{2} ) {x}_{3} \\ ( {\vert {h}_{1 , 4} \vert}^{2} + {\vert {h}_{2 , 4} \vert}^{2} ) {x}_{4}\end{matrix} ] .$$

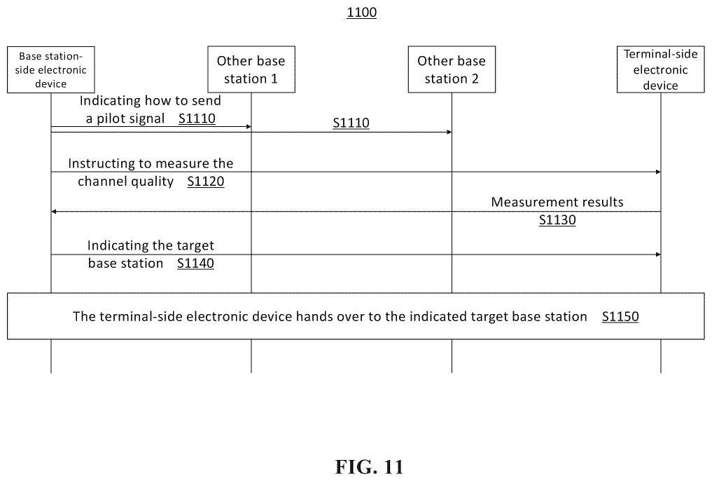

FIG. 11 illustrates an interactive flowchart of an exemplary communication process 1100 according to an embodiment of the present disclosure. The exemplary communication process 1100 may be performed by electronic devices 100 and 200 described above. The communication process 1100 may be started based on a request of the terminal-side electronic device, or may be started autonomously by the base station-side electronic device according to the measurement result of the communication channel reported by the terminal-side electronic device.

The base station-side electronic device (such as the electronic device 100, which may be referred to as a master base station in these embodiments) may select, from its neighboring base stations, other base stations (which may be referred to as secondary base stations in these embodiments) that the terminal-side electronic device may be able to measure (for example, the terminal-side electronic device may be able to receive a pilot signal of the base station). The secondary base station may be a base station that uses an OAM wave transmission device for communication, and may also be a base station that uses a plane wave transmission device (such as a MIMO transmission device) for communication. Operations of S1110 to S1130 are similar to operations of S1010 to S1030 respectively, and thus detailed descriptions thereof are omitted.

According to the measurement result fed back by the terminal-side electronic device, the master base station selects a secondary base station from the measured secondary base stations to be a target base station as a handover target. Afterwards, the master base station shares (for example, through an Xn interface) channel information with the selected target base station, and indicates information about the target base station to the terminal-side electronic device (S1140). The terminal-side electronic device hands over to the target base station according to the indicated contents (S1150). After S1140 and before S1150, each base station and the terminal-side electronic device may wait for several slots as a lag time. The set lag time may be used for preparation work, such as calculation of precoding matrix and data exchange between base stations. The precoding matrix of the target base station is calculated by the master base station according to the corresponding downlink channel estimation result, and the master base station notifies the corresponding target base station of the calculation result.

In S1140, the master base station may also use the bitmap indicator to indicate information of the target base station to the terminal-side electronic device. Table 5 shows a specific example of a bitmap indicator indicating a target base station. It can be seen that when the terminal-side electronic device receives the bitmap indicator in S1040 or S1140, if the bitmap indicator only indicates one base station (that is, there is only one 1 in values of respective bits), the bitmap indicator may indicate information about a target base station for handover; and if the bitmap indicator indicates more than one base station (that is, there is more than one 1 in values of respective bits), the bitmap indicator may indicate information about respective cooperative base stations. The terminal-side electronic device may have been configured with a base station list by the master base station. When indicating a target base station, different bits in the bitmap indicator may be used to distinguish different base station indexes in the base station list. In the specific example shown in Table 5, the master base station instructs the terminal-side electronic device to be handed over to a MIMO base station with index 3 in the base station list. Although in the specific example in Table 5, the OAM base stations and MIMO base stations in the base station list are separately indexed, it should be understood that in other examples, the OAM base stations and MIMO base stations in the base station list may also be commonly indexed.

TABLE 5
Example of a bitmap indicator indicating a target base station

| OAM base station | | | | MIMO base station | | | |
|---|---|---|---|---|---|---|---|
| 0 | 0 | 0 | 0 | 0 | 0 | 1 | 0 |
| index | index | index | index | index | index | index | index |
| 1 | 2 | 3 | 4 | 1 | 2 | 3 | 4 |

Exemplary electronic devices and methods according to the embodiments of the present disclosure have been respectively described above. It should be understood that the operations or functions of these electronic devices may be combined with each other to realize more or less operations or functions than described. Operational steps of the various methods may also be combined with each other in any suitable order to similarly achieve more or fewer operations than described.

It should be understood that a machine-readable storage medium or machine-executable instructions in a program product according to the embodiments of the present disclosure may be configured to perform operations corresponding to the above-mentioned device and method embodiments. When referring to the above-mentioned device and method embodiments, the embodiments of the machine-readable storage medium or the program product will be obvious to those skilled in the art, so the description thereof will not be repeated. Machine-readable storage media and program products for carrying or including the above-mentioned machine-executable instructions also fall within the scope of the present disclosure. Such storage media may include, but are not limited to, floppy disks, optical disks, magneto-optical disks, memory cards, memory sticks, and the like.

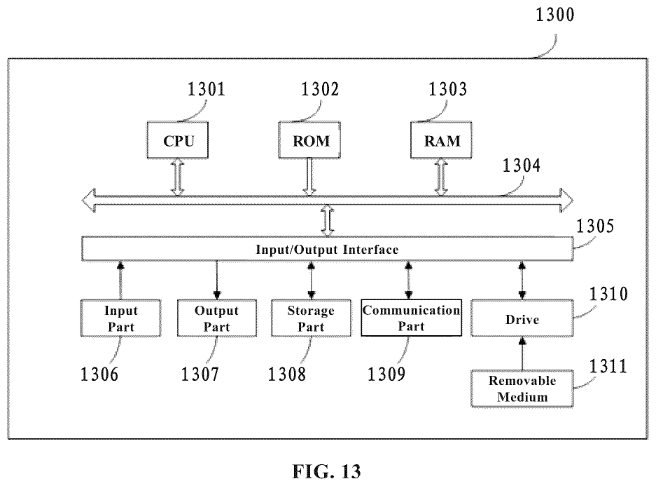

In addition, it should be understood that the series of processes and devices described above may also be implemented by software and/or firmware. In the case of implementation by software and/or firmware, a program constituting the software is installed from a storage medium or a network to a computer having a dedicated hardware configuration, such as a general-purpose personal computer 1300 shown in FIG. 13, which can perform various functions and so on when installed with various programs. FIG. 13 is a block diagram illustrating an example structure of a personal computer as an information processing device employable in embodiments of the present disclosure. In one example, the personal computer may correspond to the above-mentioned exemplary terminal device according to the present disclosure.

In FIG. 13, a central processing unit (CPU) 1301 executes various processes according to programs stored in a read only memory (ROM) 1302 or programs loaded from a storage section 1308 to a random-access memory (RAM) 1303. In a RAM 1303, data required when the CPU 1301 executes various processes and the like is also stored as necessary.

The CPU 1301, the ROM 1302, and the RAM 1303 are connected to each other via a bus 1304. An input/output interface 1305 is also connected to the bus 1304.

The following components are connected to an input/output interface 1305: an input part 1306, including a keyboard, a mouse, etc.; an output part 1307, including a display, such as a cathode ray tube (CRT), a liquid crystal display (LCD), and the like, and a speaker, etc.; a storage part 1308, including a hard disk, etc.; and a communication part 1309, including a network interface card such as a LAN card, a modem, etc. The communication part 1309 performs communication processing via a network such as the Internet.

A drive 1310 is also connected to the input/output interface 1305 as needed. A removable medium 1311 such as a magnetic disk, an optical disk, a magneto-optical disk, a semiconductor memory, or the like is mounted on the drive 1310 as necessary, so that a computer program read therefrom is installed into the storage part 1308 as necessary.

In a case of realizing the above-described series of processes by software, programs constituting the software are installed from a network such as the Internet or a storage medium such as the removable medium 1311.

Those skilled in the art should understand that such a storage medium is not limited to the removable medium 1311 shown in FIG. 13, in which a program is stored, and which is distributed separately from a device to provide the program to the user. Examples of removable media 1311 include magnetic disks (including floppy disks (registered trademark)), optical disks (including compact disk read-only memory (CD-ROM) and digital versatile disks (DVDs)), magneto-optical disks (including mini disks (MDs) (registered trademark)) and semiconductor memory. Alternatively, the storage medium may be the ROM 1302, a hard disk contained in the storage part 1308, or the like, in which a program is stored, and which is distributed to users together with devices containing them.

The technology of the present disclosure may be applied to various products. For example, the base station mentioned in this disclosure may be implemented as any type of evolved Node B (gNB), such as macro gNB and small gNB. A small gNB may be a gNB covering a cell smaller than a macro cell, such as a pico gNB, a micro gNB, and a home (femto) gNB. Alternatively, the base station may be implemented as any other type of base station, such as NodeB and base transceiver station (BTS). The base station may include: a main body configured to control wireless communication (also referred to as a base station device); and one or more remote radio heads (RRHs) arranged in places different from the main body. In addition, various types of terminals to be described below may operate as a base station by temporarily or semi-permanently performing the base station function.

For example, the terminal-side electronic device mentioned in this disclosure is also referred to as a terminal device or a user device in some examples, and may be implemented as a mobile terminal (such as a smart phone, a tablet personal computer (PC), a notebook PC, a portable game terminal, portable/dongle-type mobile routers and digital cameras) or in-vehicle terminals (such as a car navigation device). The user device may also be implemented as a terminal which performs machine-to-machine (M2M) communication (which is also known as a Machine Type Communication (MTC) terminal). In addition, the user device may be a wireless communication module (such as an integrated circuit module including a single chip) mounted on each of the above-mentioned terminals.

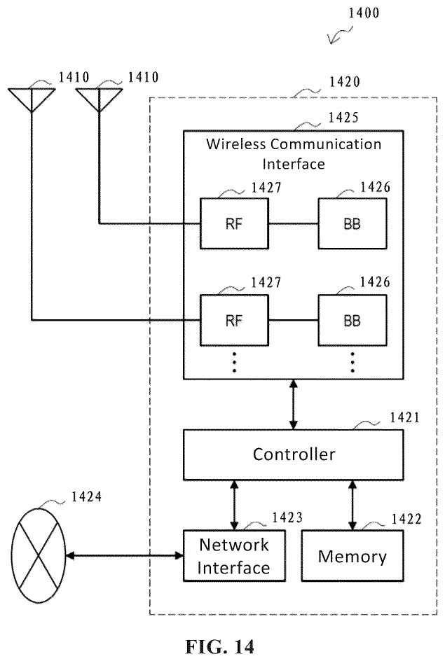

Application examples according to the present disclosure will be described below with reference to FIGS. 14 to 17.

### Application Example on Base Stations

It should be understood that the term “base station” in this disclosure has its full breadth of ordinary meaning and includes at least a wireless communication station used as a part of a wireless communication system or radio system to facilitate communication. Examples of base stations may be, for example but not limited to, the following: a base station may be one or both of a base transceiver station (BTS) and a base station controller (BSC) in a GSM system, may be one or both of a radio network controller (RNC) and Node B in a WCDMA system, may be an eNB in LTE and LTE-Advanced systems, or may be the corresponding network nodes in future communication systems (such as gNB, eLTE eNB, etc., that may appear in 5G communication systems). Part of the functions in the base station of the present disclosure may also be implemented as an entity that has a communication control function in the D2D, M2M, and V2V communication scenarios, or as an entity that plays a spectrum coordination role in the cognitive radio communication scenario.

### First Application Example

FIG. 14 is a block diagram illustrating a first example of a schematic configuration of a gNB to which the technology of the present disclosure may be applied. The gNB 1400 includes multiple antennas 1410 and a base station device 1420. The base station device 1420 and each antenna 1410 may be connected to each other via an RF cable. In an implementation manner, the gNB 1400 (or the base station device 1420) here may correspond to the above-mentioned electronic devices 300A, 1300A and/or 1500B.

Each of the antennas 1410 includes a single or multiple antenna elements, such as multiple antenna elements included in a Multiple Input Multiple Output (MIMO) antenna, and is used by the base station device 1420 to transmit and receive wireless signals. As shown in FIG. 14, the gNB 1400 may include multiple antennas 1410. For example, multiple antennas 1410 may be compatible with multiple frequency bands used by the gNB 1400.

The base station device 1420 includes a controller 1421, a memory 1422, a network interface 1423 and a wireless communication interface 1425.

The controller 1421 may be, for example, a CPU or a DSP, and may operate various functions of a higher layer of the base station device 1420. For example, the controller 1421 generates a data packet according to data in a signal processed by the wireless communication interface 1425 and transfers the generated packet via the network interface 1423. The controller 1421 may bundle data from a plurality of baseband processors to generate a bundled packet, and transfer the generated bundled packet. The controller 1421 may have a logic function to perform control such as radio resource control, radio bearer control, mobility management, admission control and scheduling. This control can be performed in conjunction with nearby gNBs or core network nodes. The memory 1422 includes RAM and ROM, and stores programs executed by the controller 1421 and various types of control data such as a terminal list, transmission power data, and scheduling data.

The network interface 1423 is a communication interface for connecting the base station device 1420 to a core network 1424. The controller 1421 may communicate with a core network node or an additional gNB via a network interface 1423. In this case, the gNB 1400 and the core network node or the additional gNBs may be connected to each other through logical interfaces (such as SI interface and X2 interface). The network interface 1423 may also be a wired communication interface or a wireless communication interface for wireless backhaul. If the network interface 1423 is a wireless communication interface, the network interface 1423 may use a higher frequency band for wireless communication than that used by the wireless communication interface 1425.

The wireless communication interface 1425 supports any cellular communication scheme such as Long-Term Evolution (LTE) and LTE-Advanced, and provides wireless connection to terminals located in a cell of the gNB 1400 via the antenna 1410. The wireless communication interface 1425 may generally include, for example, a baseband (BB) processor 1426 and a RF circuit 1427. The BB processor 1426 may perform, for example, encoding/decoding, modulation/demodulation, and multiplexing/demultiplexing, and execute various types of signal processing for layers such as L1, medium access control (MAC), radio link control (RLC), and packet data convergence protocol (PDCP). Instead of the controller 1421, the BB processor 1426 may have part or all of the above logic functions. The BB processor 1426 may be a memory storing a communication control program, or a module including a processor configured to execute a program and related circuits. The update of the program may change the function of the BB processor 1426. The module may be a card or blade inserted into a slot of the base station device 1420. Alternatively, the module may also be a chip mounted on a card or blade. Meanwhile, the RF circuit 1427 may include, for example, a mixer, a filter, and an amplifier, and may transmit and receive wireless signals via the antenna 1410. Although FIG. 14 illustrates an example in which one RF circuit 1427 is connected to one antenna 1410, the present disclosure is not limited to this illustration, but one RF circuit 1427 may be connected to a plurality of antennas 1410 at the same time.

As shown in FIG. 14, the wireless communication interface 1425 may include multiple BB processors 1426. For example, multiple BB processors 1426 may be compatible with multiple frequency bands used by the gNB 1400. As shown in FIG. 14, the wireless communication interface 1425 may include a plurality of RF circuits 1427. For example, multiple RF circuits 1427 may be compatible with multiple antenna elements. Although FIG. 14 illustrates an example in which the wireless communication interface 1425 includes a plurality of BB processors 1426 and a plurality of RF circuits 1427, the wireless communication interface 1425 may also include a single BB processor 1426 or a single RF circuit 1427.

### Second Application Example

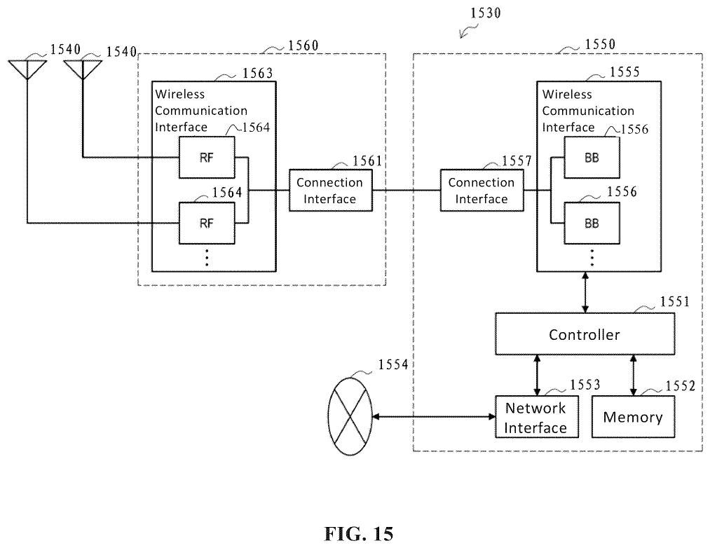

FIG. 15 is a block diagram illustrating a second example of a schematic configuration of a gNB to which the technology of the present disclosure may be applied. The gNB 1530 includes multiple antennas 1540, a base station device 1550 and an RRH 1560. The RRH 1560 and each antenna 1540 may be connected to each other via an RF cable. The base station device 1550 and the RRH 1560 may be connected to each other via a high-speed line such as an optical fiber cable. In an implementation manner, the gNB 1530 (or the base station device 1550) here may correspond to the above-mentioned electronic devices 300A, 1300A and/or 1500B.

Each of the antennas 1540 includes a single or multiple antenna elements, such as multiple antenna elements included in a MIMO antenna, and is used by the RRH 1560 to transmit and receive wireless signals. As shown in FIG. 15, the gNB 1530 may include multiple antennas 1540. For example, multiple antennas 1540 may be compatible with multiple frequency bands used by the gNB 1530.

The base station device 1550 includes a controller 1551, a memory 1552, a network interface 1553, a wireless communication interface 1555 and a connection interface 1557. The controller 1551, the memory 1552, and the network interface 1553 are the same as the controller 1421, the memory 1422, and the network interface 1423 described with reference to FIG. 14.

The wireless communication interface 1555 supports any cellular communication scheme such as LTE and LTE-Advanced, and provides wireless communication to terminals located in a sector corresponding to the RRH 1560 via the RRH 1560 and the antenna 1540. The wireless communication interface 1555 may generally include, for example, a BB processor 1556. The BB processor 1556 is the same as the BB processor 1426 described with reference to FIG. 14 except that the BB processor 1556 is connected to the RF circuit 1564 of the RRH 1560 via the connection interface 1557. As shown in FIG. 15, the wireless communication interface e 1555 may include multiple BB processors 1556. For example, multiple BB processors 1556 may be compatible with multiple frequency bands used by the gNB 1530. Although FIG. 15 illustrates an example in which the wireless communication interface 1555 includes a plurality of BB processors 1556, the wireless communication interface 1555 may also include a single BB processor 1556.

The connection interface 1557 is an interface for connecting the base station device 1550 (wireless communication interface 1555) to the RRH 1560. The connection interface 1557 may also be a communication module for communication in the above-mentioned high-speed line connecting the base station device 1550 (wireless communication interface 1555) to the RRH 1560.

The RRH 1560 includes a connection interface 1561 and a wireless communication interface 1563.

The connection interface 1561 is an interface for connecting the RRH 1560 (wireless communication interface 1563) to the base station device 1550. The connection interface 1561 may also be a communication module for communication in the above-mentioned high-speed line.

The wireless communication interface 1563 transmits and receives wireless signals via the antenna 1540. Wireless communication interface 1563 may generally include a RF circuit 1564, for example. The RF circuit 1564 may include, for example, a mixer, a filter, and an amplifier, and transmits and receives wireless signals via the antenna 1540. Although FIG. 15 illustrates an example in which one RF circuit 1564 is connected to one antenna 1540, the present disclosure is not limited to this illustration, but one RF circuit 1564 may be connected to a plurality of antennas 1540 at the same time.

As shown in FIG. 15, the wireless communication interface 1563 may include a plurality of RF circuits 1564. For example, multiple RF circuits 1564 may support multiple antenna elements. Although FIG. 15 illustrates an example in which the wireless communication interface 1563 includes a plurality of RF circuits 1564, the wireless communication interface 1563 may also include a single RF circuit 1564.

### Application Example on User Device

### First Application Example

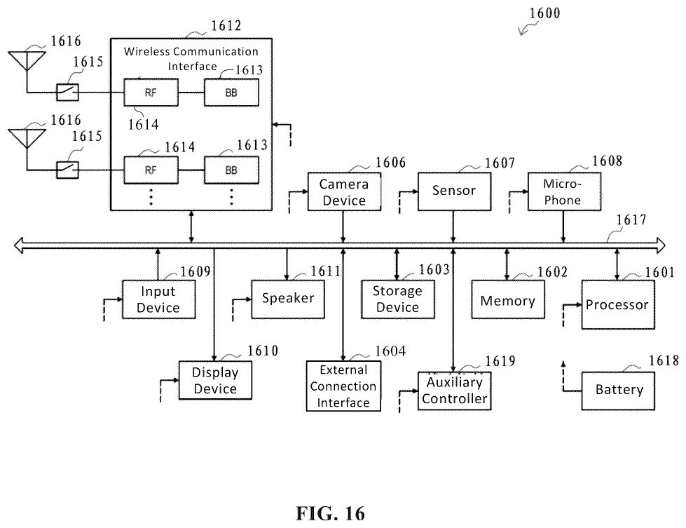

FIG. 16 is a block diagram illustrating an example of a schematic configuration of a smartphone 1600 to which the technology of the present disclosure may be applied. The smart phone 1600 includes a processor 1601, a memory 1602, a storage device 1603, an external connection interface 1604, a camera device 1606, a sensor 1607, a microphone 1608, an input device 1609, a display device 1610, a speaker 1611, a wireless communication interface 1612, one or more antenna switches 1615, one or more antennas 1616, a bus 1617, a battery 1618, and an auxiliary controller 1619. In an implementation manner, the smartphone 1600 (or the processor 1601) here may correspond to the above-mentioned terminal devices 300B and/or 1500A.

The processor 1601 may be, for example, a CPU or a system on a chip (SoC), and may control functions of application layers and other layers of the smartphone 1600. The memory 1602 includes RAM and ROM, and stores data and programs executed by the processor 1601. The storage device 1603 may include a storage medium such as a semiconductor memory and a hard disk. The external connection interface 1604 is an interface for connecting an external device such as a memory card and a universal serial bus (USB) device to the smartphone 1600.

The camera device 1606 includes an image sensor such as a charge coupled device (CCD) and a complementary metal oxide semiconductor (CMOS), and generates a captured image. The sensors 1607 may include a set of sensors such as measurement sensors, gyro sensors, geomagnetic sensors, and acceleration sensors. The microphone 1608 converts sound input to the smartphone 1600 into an audio signal. The input device 1609 includes, for example, a touch sensor configured to detect a touch on a screen of the display device 1610, a keypad, a keyboard, buttons, or switches, and receives operations or information input from the user. The display device 1610 includes the screen such as a Liquid Crystal Display (LCD) and an Organic Light Emitting Diode (OLED) display, and displays an output image of the smartphone 1600. The speaker 1611 converts an audio signal output from the smartphone 1600 into sound.

The wireless communication interface 1612 supports any cellular communication scheme such as LTE and LTE-Advanced, and performs wireless communication. The wireless communication interface 1612 may generally include, for example, a BB processor 1613 and an RF circuit 1614. The BB processor 1613 may perform, for example, encoding/decoding, modulation/demodulation, and multiplexing/demultiplexing, and perform various types of signal processing for wireless communication. Meanwhile, the RF circuit 1614 may include, for example, a mixer, a filter, and an amplifier, and transmits and receives wireless signals via the antenna 1616. The wireless communication interface 1612 may be a chip module on which a BB processor 1613 and an RF circuit 1614 are integrated. As shown in FIG. 16, the wireless communication interface 1612 may include multiple BB processors 1613 and multiple RF circuits 1614. Although FIG. 16 illustrates an example in which the wireless communication interface 1612 includes a plurality of BB processors 1613 and a plurality of RF circuits 1614, the wireless communication interface 1612 may also include a single BB processor 1613 or a single RF circuit 1614.

Besides, the wireless communication interface 1612 may support another type of wireless communication scheme, such as a short-range wireless communication scheme, a near field communication scheme, and a wireless local area network (LAN) scheme, in addition to the cellular communication scheme. In this case, the wireless communication interface 1612 may include a BB processor 1613 and an RF circuit 1614 for each wireless communication scheme.

Each of the antenna switches 1615 switches the connection destination of the antenna 1616 among a plurality of circuits, such as circuits for different wireless communication schemes, included in the wireless communication interface 1612.

Each of the antennas 1616 includes a single or multiple antenna elements, such as multiple antenna elements included in a MIMO antenna, and is used by the wireless communication interface 1612 to transmit and receive wireless signals. As shown in FIG. 16, the smartphone 1600 may include multiple antennas 1616. Although FIG. 16 illustrates an example in which the smartphone 1600 includes multiple antennas 1616, the smartphone 1600 may also include a single antenna 1616.

In addition, the smartphone 1600 may include an antenna 1616 for each wireless communication scheme. In this case, the antenna switch 1615 may be omitted from the configuration of the smartphone 1600.

The bus 1617 connects the processor 1601, the memory 1602, the storage device 1603, the external connection interface 1604, the camera device 1606, the sensor 1607, the microphone 1608, the input device 1609, the display device 1610, the speaker 1611, the wireless communication interface 1612, and the auxiliary controller 1619 to each other. The battery 1618 provides power to the various blocks of the smartphone 1600 shown in FIG. 16 via feed lines, which are partially shown as dotted lines in the figure. The auxiliary controller 1619 operates minimum necessary functions of the smartphone 1600, for example, in a sleep mode.

### Second Application Example

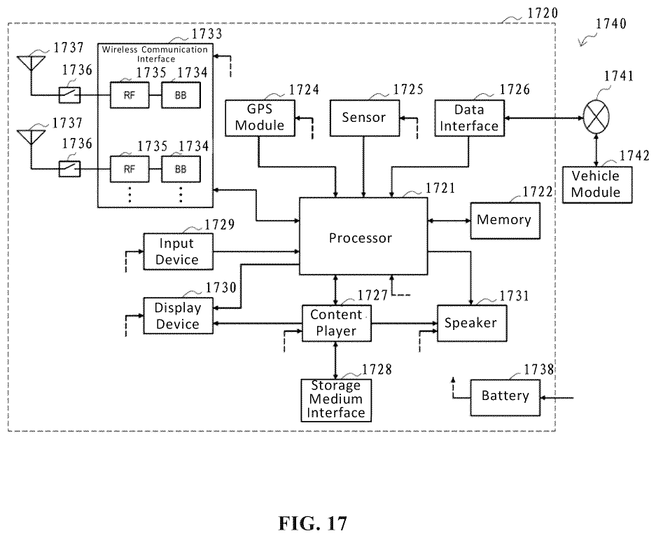

FIG. 17 is a block diagram illustrating an example of a schematic configuration of a car navigation device 1720 to which the technology of the present disclosure may be applied. The car navigation device 1720 includes a processor 1721, a memory 1722, a global positioning system (GPS) module 1724, a sensor 1725, a data interface 1726, a content player 1727, a storage medium interface 1728, an input device 1729, a display device 1730, a speaker 1731, a wireless communication interface 1733, one or more antenna switches 1736, one or more antennas 1737, and a battery 1738. In an implementation manner, the car navigation device 1720 (or the processor 1721) here may correspond to the above-mentioned terminal device 300B and/or 1500A.

The processor 1721 may be, for example, a CPU or a SoC, and may control a navigation function and other functions of the car navigation device 1720. The memory 1722 includes RAM and ROM, and stores data and programs executed by the processor 1721.

The GPS module 1724 measures the location (such as latitude, longitude, and altitude) of the car navigation device 1720 by using GPS signals received from GPS satellites. The sensors 1725 may include a set of sensors such as gyroscopic sensors, geomagnetic sensors, and air pressure sensors. The data interface 1726 is connected to, for example, an in-vehicle network 1741 via a terminal not shown, and acquires data generated by the vehicle such as vehicle speed data.

The content player 1727 reproduces content stored in a storage medium such as CD and DVD, which is inserted into the storage medium interface 1728. The input device 1729 includes, for example, a touch sensor configured to detect a touch on a screen of the display device 1730, a button, or a switch, and receives an operation or information input from a user. The display device 1730 includes the screen such as an LCD or OLED display, and displays an image of a navigation function or reproduced contents. The speaker 1731 outputs sound of a navigation function or reproduced contents.

The wireless communication interface 1733 supports any cellular communication scheme such as LTE and LTE-Advanced, and performs wireless communication. The wireless communication interface 1733 may generally include, for example, a BB processor 1734 and an RF circuit 1735. The BB processor 1734 may perform, for example, encoding/decoding, modulation/demodulation, and multiplexing/demultiplexing, and perform various types of signal processing for wireless communication. Meanwhile, the RF circuit 1735 may include, for example, a mixer, a filter, and an amplifier, and transmit and receive wireless signals via the antenna 1737. The wireless communication interface 1733 may also be a chip module on which the BB processor 1734 and the RF circuit 1735 are integrated. As shown in FIG. 17, the wireless communication interface 1733 may include multiple BB processors 1734 and multiple RF circuits 1735. Although FIG. 17 illustrates an example in which the wireless communication interface 1733 includes a plurality of BB processors 1734 and a plurality of RF circuits 1735, the wireless communication interface 1733 may also include a single BB processor 1734 or a single RF circuit 1735.

Besides, the wireless communication interface 1733 may support another type of wireless communication scheme, such as a short-range wireless communication scheme, a near field communication scheme, and a wireless LAN scheme, in addition to the cellular communication scheme. In this case, the wireless communication interface 1733 may include a BB processor 1734 and an RF circuit 1735 for each wireless communication scheme.

Each of the antenna switches 1736 switches the connection destination of the antenna 1737 among a plurality of circuits included in the wireless communication interface 1733, such as circuits for different wireless communication schemes.

Each of the antennas 1737 includes a single or a plurality of antenna elements such as a plurality of antenna elements included in a MIMO antenna, and is used by the wireless communication interface 1733 to transmit and receive wireless signals. As shown in FIG. 17, the car navigation device 1720 may include a plurality of antennas 1737. Although FIG. 17 illustrates an example in which the car navigation device 1720 includes a plurality of antennas 1737, the car navigation device 1720 may also include a single antenna 1737.

In addition, the car navigation device 1720 may include an antenna 1737 for each wireless communication scheme. In this case, the antenna switch 1736 may be omitted from the configuration of the car navigation device 1720.

The battery 1738 supplies power to the various blocks of the car navigation device 1720 shown in FIG. 17 via feed lines, which are partially shown as dotted lines in the figure. The battery 1738 accumulates electric power supplied from the vehicle.

The technology of the present disclosure may also be implemented as an in-vehicle system (or vehicle) 1740 including one or more blocks of the car navigation device 1720, the in-vehicle network 1741, and a vehicle module 1742. The vehicle module 1742 generates vehicle data such as vehicle speeds, engine speeds, and failure information, and outputs the generated data to the in-vehicle network 1741.

### Exemplary Method

In addition, implementations of the present disclosure may also include the following examples:

1. A base station-side electronic device for a wireless communication system, including a processing circuitry configured to:
determine a distance between the base station-side electronic device and a terminal-side electronic device; and
determine, based on the distance, a Rayleigh distance for Orbital Angular Momentum (OAM) wave-based communication between the base station-side electronic device and the terminal-side electronic device, such that at least two modes of OAM waves can be used for transmission between the base station-side electronic device and the terminal-side electronic device.

2. The electronic device according to 1, wherein the processing circuitry is further configured to: determine, based on the distance, the Rayleigh distance for OAM wave-based communication between the base station-side electronic device and the terminal-side electronic device, such that the distance is not greater than a times the Rayleigh distance, where 0<α≤10.

3. The electronic device according to 1, wherein the processing circuitry is further configured to:
determine, based on the Rayleigh distance, a transmission frequency of OAM wave communication between the base station-side electronic device and the terminal-side electronic device.

4. The electronic device according to 3, wherein the processing circuitry is further configured to:
determine, based on the Rayleigh distance and an antenna aperture of an OAM wave antenna of the base station-side electronic device, a transmission frequency of an OAM wave-based downlink for the terminal-side electronic device; and
notify the terminal-side electronic device of information indicating the transmission frequency of the downlink.

5. The electronic device according to 3 or 4, wherein the processing circuitry is further configured to:
receive, from the terminal-side electronic device, information indicating an antenna aperture of an OAM wave antenna of the terminal-side electronic device;
determine, based on the Rayleigh distance and the antenna aperture of the OAM wave antenna of the terminal-side electronic device, a transmission frequency of an OAM wave-based uplink for the terminal-side electronic device; and
notify the terminal-side electronic device of information indicating the transmission frequency of the uplink.

6. The electronic device according to 3 or 4, wherein the processing circuitry is further configured to:
notify, through plane wave communication, the terminal-side electronic device of the determined transmission frequency for OAM wave communication between the base station-side electronic device and the terminal-side electronic device.

7. The electronic device according to 3, wherein the terminal-side electronic device includes a first terminal-side electronic device and a second terminal-side electronic device, and the processing circuitry is further configured to:
determine a first distance between the base station-side electronic device and the first terminal-side electronic device and a second distance between the base station-side electronic device and the second terminal-side electronic device, wherein the first distance is greater than the second distance;
determine, based on the first distance, a first transmission frequency for OAM wave communication between the base station-side electronic device and the first terminal-side electronic device, and determine, based on the second distance, a second transmission frequency for OAM wave communication between the base station-side electronic device and the second terminal-side electronic device, wherein the first transmission frequency is higher than the second transmission frequency; and
notify the first terminal-side electronic device of information indicating the first transmission frequency, and notify the second terminal-side electronic device of information indicating the second transmission frequency.

8. The electronic device according to 1, wherein the processing circuitry is further configured to:
determine, based on the Rayleigh distance, an OAM wave transmission device of the base station-side electronic device for OAM wave communication with the terminal-side electronic device.

Optionally, in the electronic device according to 8, the processing circuitry is further configured to:
determine, based on the Rayleigh distance and a transmission frequency of an OAM wave-based downlink between the base station-side electronic device and the terminal-side electronic device, an antenna aperture of an OAM wave antenna for the downlink, and determine an OAM wave antenna with the antenna aperture of the base station-side electronic device as the OAM wave transmission device for the OAM wave-based downlink between the base station-side electronic device and the terminal-side electronic device; and
transmit signals for the terminal-side electronic device on the downlink through the determined OAM wave transmission device of the base station-side electronic device for the OAM wave-based downlink between the base station-side electronic device and the terminal-side electronic device.

Optionally, in the electronic device according to 8, the terminal-side electronic device includes a first terminal-side electronic device and a second terminal-side electronic device, and the OAM wave transmission device of the base station-side electronic device includes a first OAM wave antenna and a second OAM wave antenna, and the processing circuitry is further configured to:
determine a first distance between the base station-side electronic device and the first terminal-side electronic device and a second distance between the base station-side electronic device and the second terminal-side electronic device, wherein the first distance is greater than the second distance;
determine, based on the first distance, a first antenna aperture for an OAM wave-based downlink between the base station-side electronic device and the first terminal-side electronic device, and determine, based on the second distance, a second antenna aperture for an OAM wave-based downlink between the base station-side electronic device and the second terminal-side electronic device, wherein the first antenna aperture is larger than the second antenna aperture; and
transmit signals for the first terminal-side electronic device by the first OAM wave antenna having the first antenna aperture on the OAM wave-based downlink between the base station-side electronic device and the first terminal-side electronic device, and transmit signals for the second terminal-side electronic device by the second OAM wave antenna having the second antenna aperture on the OAM wave-based downlink between the base station-side electronic device and the second terminal-side electronic device.

9. The electronic device according to 1, wherein the processing circuitry is further configured to:
receive, from the terminal-side electronic device, information indicating a status of a communication channel between the base station-side electronic device and the terminal-side electronic device; and
determine, according to the status of the communication channel, to use an OAM wave transmission device and/or a plane wave transmission device of the base station-side electronic device to communicate with the terminal-side electronic device.

10. The electronic device according to 9, wherein the status of the communication channel is a multipath status of the communication channel, and the processing circuitry is further configured to:
determine, in response to the multipath status of the communication channel indicating that there is a line-of-sight (LOS) path, to use the OAM wave transmission device to communicate with the terminal-side electronic device; and
determine, in response to the multipath status of the communication channel indicating that there is no LOS path while energy of a non-line-of-sight (NLOS) path is greater than a threshold, to use a multiple-input multiple-output (MIMO) plane wave transmission device of the base station-side electronic device to communicate with the terminal-side electronic device.

11. The electronic device according to 1, wherein the processing circuitry is configured to:
send, to the terminal-side electronic device, information instructing the terminal-side electronic device to measure a communication channel between the terminal-side electronic device and one or more other base stations;
determine one or more cooperative base stations from the one or more other base stations according to the measurement result from the terminal-side electronic device; and
notify the terminal-side electronic device of information indicating the one or more cooperative base stations.

12. The electronic device according to claim 1, wherein the processing circuitry is configured to:
send, to the terminal-side electronic device, information instructing the terminal-side electronic device to measure a communication channel between the terminal-side electronic device and one or more other base stations;
determine a target base station as a handover target from the one or more other base stations according to the measurement result from the terminal-side electronic device; and
notify the terminal-side electronic device of information instructing the terminal-side electronic device to be handed over to the target base station.

13. A method for a base station-side electronic device for a wireless communication system, including:
determining a distance between the base station-side electronic device and a terminal-side electronic device;
determining, based on the distance and an antenna aperture of an OAM wave antenna of the base station-side electronic device, a transmission frequency of an OAM wave-based downlink for the terminal-side electronic device; and
notifying the terminal-side electronic device of information indicating the transmission frequency of the downlink.

14. The method according to 13, further including:
receiving, from the terminal-side electronic device, information indicating an antenna aperture of an OAM wave antenna of the terminal-side electronic device;
determining, based on the distance and the antenna aperture of the OAM wave antenna of the terminal-side electronic device, a transmission frequency of an OAM wave-based uplink for the terminal-side electronic device; and
notifying the terminal-side electronic device of information indicating the transmission frequency of the uplink.

15. A terminal-side electronic device for a wireless communication system, including a processing circuitry configured to:
receive, from a base station-side electronic device, information indicating a transmission frequency of an Orbital Angular Momentum (OAM) wave-based downlink; and
receive a signal on the downlink based on an OAM antenna of the terminal-side electronic device and the transmission frequency of the downlink.

16. The electronic device according to 15, wherein the processing circuitry is further configured to:
send, to the base station-side electronic device, information for determining a distance between the base station-side electronic device and the terminal-side electronic device, before receiving the information indicating the transmission frequency of the downlink from the base station-side electronic device.

17. The electronic device according to 15, wherein the processing circuitry is further configured to:
send, to the base station-side electronic device, information indicating an antenna aperture of an OAM antenna of the terminal-side electronic device;
receive, from the base station-side electronic device, information indicating a transmission frequency of an OAM wave-based uplink; and
transmit a signal on the uplink based on an OAM antenna of the terminal-side electronic device and the transmission frequency of the uplink.

Optionally, in the electronic device according to 15, the processing circuitry is further configured to:
receive, by a plane wave transmission resource, information indicating the transmission frequency of the orbital angular momentum (OAM) wave-based downlink from the base station-side electronic device.

18. The electronic device according to 15, wherein the processing circuitry is further configured to:
send, to the base station-side electronic device, information indicating a status of a communication channel between the base station-side electronic device and the terminal-side electronic device; and
receive, from the base station-side electronic device, information indicating the use of an OAM wave transmission device and/or a plane wave transmission device, and communicate with the base station-side electronic device using the indicated OAM wave transmission device and/or plane wave transmission device.

19. The electronic device according to 15, wherein the processing circuitry is further configured to:
receive, from the base station-side electronic device, information instructing to measure a communication channel between the terminal-side electronic device and one or more other base stations;
send the measurement result to the base station-side electronic device; and
receive, from the base station-side electronic device, information indicating one or more cooperative base stations, and communicate with the base station-side electronic device and the one or more cooperative base stations according to indicated content.

20. The electronic device according to 15, wherein the processing circuitry is further configured to:
receive, from the base station-side electronic device, information instructing to measure a communication channel between the terminal-side electronic device and one or more other base stations;
send the measurement result to the base station-side electronic device; and
receive, from the base station-side electronic device, information instructing the terminal-side electronic device to be handed over to a target base station as a handover target, and perform a handover according to indicated content.

The exemplary embodiments of the present disclosure are described above with reference to the accompanying drawings, but the present disclosure is of course not limited to the above examples. A person skilled in the art may obtain various alterations and modifications within the scope of the appended claims, and it should be understood that these alterations and modifications will naturally fall within the technical scope of the present disclosure.

For example, a plurality of functions included in one unit in the above embodiments may be realized by separate devices. Alternatively, a plurality of functions implemented by a plurality of units in the above embodiments may be respectively implemented by separate devices. In addition, one of the above functions may be realized by a plurality of units. Needless to say, such a configuration is included in the technical scope of the present disclosure.

In this specification, the steps described in the flowcharts include not only processing performed in time series in the stated order but also processing performed in parallel or individually and not necessarily in time series. Furthermore, even in the steps of time-series processing, needless to say, the order can be appropriately changed.

Although the present disclosure and its advantages have been described in detail, it should be understood that various changes, substitutions and alterations can be made hereto without departing from the spirit and scope of the present disclosure as defined by the appended claims. Moreover, the terms “comprise”, “comprising”, “include”, “including” or any other variation thereof in the embodiments of the present disclosure are intended to cover a non-exclusive inclusion, such that a process, method, article, or device including a series of elements includes not only those elements, but also other elements not expressly listed, or also elements inherent in such process, method, article or device. Without further limitations, an element defined by the phrase “including a/an . . . ” does not exclude the presence of additional identical elements in the process, method, article or device including said elements.

What is claimed is:

1. A base station-side electronic device for a wireless communication system, comprising a processing circuitry configured to:
determine a distance between the base station-side electronic device and a terminal-side electronic device; and
determine, based on the distance, a Rayleigh distance for Orbital Angular Momentum (OAM) wave-based communication between the base station-side electronic device and the terminal-side electronic device, such that at least two modes of OAM waves can be used for transmission between the base station-side electronic device and the terminal-side electronic device.

2. The base station-side electronic device according to claim 1, wherein the processing circuitry is further configured to: determine, based on the distance, the Rayleigh distance for OAM wave-based communication between the base station-side electronic device and the terminal-side electronic device, such that the distance is not greater than a times the Rayleigh distance, where 0<α≥10.

3. The base station-side electronic device according to claim 1, wherein the processing circuitry is further configured to:
determine, based on the Rayleigh distance, a transmission frequency for OAM wave communication between the base station-side electronic device and the terminal-side electronic device.

4. The base station-side electronic device according to claim 3, wherein the processing circuitry is further configured to:
determine, based on the Rayleigh distance and an antenna aperture of an OAM wave antenna of the base station-side electronic device, a transmission frequency of an OAM wave-based downlink for the terminal-side electronic device; and
notify the terminal-side electronic device of information indicating the transmission frequency of the downlink.

5. The base station-side electronic device according to claim 3, wherein the processing circuitry is further configured to:
receive, from the terminal-side electronic device, information indicating an antenna aperture of an OAM wave antenna of the terminal-side electronic device;
determine, based on the Rayleigh distance and the antenna aperture of the OAM wave antenna of the terminal-side electronic device, a transmission frequency of an OAM wave-based uplink for the terminal-side electronic device; and
notify the terminal-side electronic device of information indicating the transmission frequency of the uplink.

6. The base station-side electronic device according to claim 3, wherein the processing circuitry is further configured to:
notify, through plane wave communication, the terminal-side electronic device of the determined transmission frequency for OAM wave communication between the base station-side electronic device and the terminal-side electronic device.

7. The base station-side electronic device according to claim 3, wherein the terminal-side electronic device comprises a first terminal-side electronic device and a second terminal-side electronic device, and the processing circuitry is further configured to:
determine a first distance between the base station-side electronic device and the first terminal-side electronic device and a second distance between the base station-side electronic device and the second terminal-side electronic device, wherein the first distance is greater than the second distance;
determine, based on the first distance, a first transmission frequency for OAM wave communication between the base station-side electronic device and the first terminal-side electronic device, and determine, based on the second distance, a second transmission frequency for OAM wave communication between the base station-side electronic device and the second terminal-side electronic device, wherein the first transmission frequency is higher than the second transmission frequency; and
notify the first terminal-side electronic device of information indicating the first transmission frequency, and notify the second terminal-side electronic device of information indicating the second transmission frequency.

8. The base station-side electronic device according to claim 1, wherein the processing circuitry is further configured to:
determine, based on the Rayleigh distance, an OAM wave transmission device of the base station-side electronic device for OAM wave communication with the terminal-side electronic device.

9. The base station-side electronic device according to claim 1, wherein the processing circuitry is further configured to:
receive, from the terminal-side electronic device, information indicating a status of a communication channel between the base station-side electronic device and the terminal-side electronic device; and
determine, according to the status of the communication channel, to use an OAM wave transmission device and/or a plane wave transmission device of the base station-side electronic device to communicate with the terminal-side electronic device.

10. The base station-side electronic device according to claim 9, wherein the status of the communication channel is a multipath status of the communication channel, and the processing circuitry is further configured to:
determine, in response to the multipath status of the communication channel indicating that there is a line-of-sight (LOS) path, to use the OAM wave transmission device to communicate with the terminal-side electronic device; and
determine, in response to the multipath status of the communication channel indicating that there is no LOS path while energy of a non-line-of-sight (NLOS) path is greater than a threshold, to use a multiple-input multiple-output (MIMO) plane wave transmission device of the base station-side electronic device to communicate with the terminal-side electronic device.

11. The base station-side electronic device according to claim 1, wherein the processing circuitry is configured to:
send, to the terminal-side electronic device, information instructing the terminal-side electronic device to measure a communication channel between the terminal-side electronic device and one or more other base stations;
determine one or more cooperative base stations from the one or more other base stations according to the measurement result from the terminal-side electronic device; and
notify the terminal-side electronic device of information indicating the one or more cooperative base stations.

12. The base station-side electronic device according to claim 1, wherein the processing circuitry is configured to:
send, to the terminal-side electronic device, information instructing the terminal-side electronic device to measure a communication channel between the terminal-side electronic device and one or more other base stations;
determine a target base station as a handover target from the one or more other base stations according to the measurement result from the terminal-side electronic device; and
notify the terminal-side electronic device of information instructing the terminal-side electronic device to be handed over to the target base station.

13. A method for a base station-side electronic device for a wireless communication system, comprising:
determining a distance between the base station-side electronic device and a terminal-side electronic device;
determining, based on the distance and an antenna aperture of an OAM wave antenna of the base station-side electronic device, a transmission frequency of an OAM wave-based downlink for the terminal-side electronic device; and
notifying the terminal-side electronic device of information indicating the transmission frequency of the downlink.

14. The method according to claim 13, further comprising:
receiving, from the terminal-side electronic device, information indicating an antenna aperture of an OAM wave antenna of the terminal-side electronic device;
determining, based on the distance and the antenna aperture of the OAM wave antenna of the terminal-side electronic device, a transmission frequency of an OAM wave-based uplink for the terminal-side electronic device; and
notifying the terminal-side electronic device of information indicating the transmission frequency of the uplink.

15. A terminal-side electronic device for a wireless communication system, comprising a processing circuitry configured to:
receive, from a base station-side electronic device, information indicating a transmission frequency of an Orbital Angular Momentum (OAM) wave-based downlink; and
receive a signal on the downlink based on an OAM antenna of the terminal-side electronic device and the transmission frequency of the downlink.

16. The terminal-side electronic device according to claim 15, wherein the processing circuitry is further configured to:
send, to the base station-side electronic device, information for determining a distance between the base station-side electronic device and the terminal-side electronic device, before receiving the information indicating the transmission frequency of the downlink from the base station-side electronic device.

17. The terminal-side electronic device according to claim 15, wherein the processing circuitry is further configured to:
send, to the base station-side electronic device, information indicating an antenna aperture of an OAM antenna of the terminal-side electronic device;
receive, from the base station-side electronic device, information indicating a transmission frequency of an OAM wave-based uplink; and
transmit a signal on the uplink based on an OAM antenna of the terminal-side electronic device and the transmission frequency of the uplink.

18. The terminal-side electronic device according to claim 15, wherein the processing circuitry is further configured to:
send, to the base station-side electronic device, information indicating a status of a communication channel between the base station-side electronic device and the terminal-side electronic device; and
receive, from the base station-side electronic device, information indicating the use of an OAM wave transmission device and/or a plane wave transmission device, and communicate with the base station-side electronic device using the indicated OAM wave transmission device and/or plane wave transmission device.

19. The terminal-side electronic device according to claim 15, wherein the processing circuitry is further configured to:
receive, from the base station-side electronic device, information instructing to measure a communication channel between the terminal-side electronic device and one or more other base stations;
send the measurement result to the base station-side electronic device; and
receive, from the base station-side electronic device, information indicating one or more cooperative base stations, and communicate with the base station-side electronic device and the one or more cooperative base stations according to indicated content.

20. The terminal-side electronic device according to claim 15, wherein the processing circuitry is further configured to:
receive, from the base station-side electronic device, information instructing to measure a communication channel between the terminal-side electronic device and one or more other base stations;
send the measurement result to the base station-side electronic device; and
receive, from the base station-side electronic device, information instructing the terminal-side electronic device to be handed over to a target base station as a handover target, and perform a handover according to indicated content.
